(19) United States
(12) Patent Application Publication
(10) Pub. No.: US 2023/0284571 A1
(43) Pub. Date: Sep. 14, 2023

(54) PLANT SUPPORT AND STRUCTURE SYSTEM

(71) Applicant: ECO SHIELD SYSTEMS PTY LTD., Sydney (AU)

(72) Inventors: Daniel GRIFFIN, Sydney (AU); Antony Douglas GRIMES, Sydney (AU)

(73) Assignee: ECO SHIELD SYSTEMS PTY LTD., Sydney (AU)

(21) Appl. No.: 17/999,768

(22) PCT Filed: May 27, 2021
(86) PCT No.: PCT/AU2021/050509

§ 371 Date: Nov. 23, 2022

(30) Foreign Application Priority Data
May 27, 2020 (AU) 2020901728

(51) Int. Cl. A01G 9/24; A01G 9/02; A01G 27/02

(52) U.S. Cl. CPC A01G 9/247; A01G 9/025; A01G 27/02

(57) ABSTRACT

A plant support structure for accommodating plants is described. The plant support structure includes a framework in a vertically extending arrangement forming a plurality of geometric blocks and vertically extending channels formed at a periphery of the geometric blocks. The channels are configured to receive therein a porous material for carrying water from a top end of the plant support structure down the channels for irrigating plants in the channels. A system for accommodating and maintaining plants includes the plant support structure.

### CROSS REFERENCE TO RELATED APPLICATION

The present application is a national stage filing under section 371 of International Application No. PCT/AU2021/050509 filed on 27 May 2021 and published on Dec. 2, 2021 as WO 2021/237294 A1 which International Application No. PCT/AU2021/050509 filed on 27 May 2021 claims priority to Australian Provisional Patent Application No 2020901728 filed 27 May 2020, the content of which Australian Provisional Patent Application No 2020901728 filed 27 May 2020 is incorporated herein by reference in its entirety. The content of WO 2021/237294 A1 is incorporated herein by reference in its entirety.

### FIELD

The present disclosure relates to a plant support structure and plant support system for accommodating plants.

### BACKGROUND

Over the last century, various human activities such as the clearing of forests and natural ecosystems for agriculture, industry, commercial and residential real estate and other human activities has decreased the amount of flora and fauna in the environment. For many, the absence of flora has a detrimental effect on at least the aesthetics of a built environment. The absence of fauna also has a detrimental effect on the flora and the biodiversity of the built environment. Additionally, many cities are beginning to suffer from a “heat island effect”, in which built up areas are hotter than nearby rural areas.

Recently, some systems such as green façade system, green walls, and living walls have been developed to introduce nature into the urban environment. A green façade uses a trellis system to hold the vines of plants that are rooted in the ground whereas in a living wall the plants are rooted in the wall modules.

### SUMMARY OF THE DISCLOSURE

According to a first aspect of the disclosure, there is provided a plant support structure for accommodating plants, the plant support structure including: a framework including a plurality of primary elements interconnected to each other in a vertically extending arrangement, the interconnected primary elements forming a plurality of geometric blocks and vertically extending channels formed at a periphery of the geometric blocks; wherein the channels are configured to receive therein a porous material for carrying water from a top end of the plant support structure down the channels for irrigating plants in the channels.

A plant support structure for accommodating plants is also described. The plant support structure includes a framework in a vertically extending arrangement forming a plurality of geometric blocks and vertically extending channels formed at a periphery of the geometric blocks. The channels are configured to receive therein a porous material for carrying water from a top end of the plant support structure down the channels for irrigating plants in the channels.

In an embodiment, at least one of the primary elements has a micro-awning for proving shading to plants within the channels and/or to a building associated with the plant support structure.

In an embodiment, the interconnected primary elements in the framework form an interlaced hexagonal geometry.

In an embodiment, the geometric blocks form an interlaced hexagonal geometry.

In an embodiment, the framework has a first layer and a second layer of interconnected primary elements, horizontally spaced apart from the first layer; wherein the channels are formed between the first layer and the second layer.

In an embodiment, the channels are open on two sides.

In an embodiment, the channels substantially continually descend, by not including sections that extend substantially horizontally.

In an embodiment, the channels do not include sections that extend substantially horizontally.

In an embodiment, the channels continuously descend vertically over their length.

In an embodiment, the porous material is configured to accommodate and integrate roots of the plants.

In an embodiment, the framework may be formed by or include a plurality of primary elements interconnected to each other.

According to a second aspect of the disclosure, there is provided a system for accommodating and maintaining plants including a plant support structure according to the first aspect; a porous material held within the channels; and an irrigation system for providing water into a top part of the channels of the plant support structure.

There is also disclosed a system for accommodating and maintaining plants including a plant support structure, including a framework with vertically extending channels, for example as described above. The channels are configured to receive therein a porous material for carrying water from a top end of the plant support structure down the channels for irrigating plants in the channels. An irrigation system is configured to provide water into a top part of the channels of the plant support structure.

In an embodiment, the system further includes a water treatment pond located near a bottom end of the plant support structure, wherein the water treatment pond is configured to receive and purify water resulting from irrigation overflow through the channels of the plant support structure.

In an embodiment, the system further includes a water storage tank for storing either the water resulting from irrigation overflow through the channels of the plant support structure or the purified water received from the water treatment pond.

In an embodiment, the system further includes a cistern located at a height close or above the height of the plant support structure, wherein the cistern receives water from the water storage tank and provides the water to the irrigation system.

In an embodiment, the system further includes a power source and a pump for pumping water from the water storage tank to the cistern.

In an embodiment, the pump is be powered by solar energy to pump the water to the cistern.

According to a third aspect of the disclosure, there is provided a plant support structure for accommodating plants including: a framework including at least two layers of a plurality of geometric blocks, horizontally spaced part to form a space between the geometric block; and a porous material secured within the space between the geometric blocks, whereby the geometric blocks and porous material form vertically extending channels for carrying water down the channels.

In an embodiment, the vertically extending channels may form a non-linear path that substantially continuously descends along its length.

In an embodiment, the framework is formed from fibre reinforced concrete.

In an embodiment, the porous material is a wicking material.

In an embodiment, the geometric blocks are hexagonal shaped and oriented with a vertex as an uppermost part of each block.

In an embodiment, the geometric blocks include one or more elongated hexagonal shaped blocks, providing increased separation between parts of the plant support structure at the location of the elongated blocks relative to non-elongated hexagonal shaped blocks.

In an embodiment, the plant support structure is affixed to a structure so that the at least two layers are spaced apart from the structure.

In an embodiment, the plant support structure further includes one more platforms between an innermost layer of the at least two layers and the building, the platforms configured to accommodate thereon a person.

In an embodiment, each geometric block of a plant support structure as described herein may have a continuous line of thickened material extending down both sides of its periphery, relative to material to one or both sides of the line of thickened material.

Further aspects of the present disclosure and further embodiments of the aspects described in the preceding paragraphs will become apparent from the following description, given by way of example and with reference to the accompanying drawings.

### BRIEF DESCRIPTION OF THE DRAWINGS

FIGS. 1a and 2a show a front view of a plant support structure in accordance with a first embodiment of the present disclosure.

FIGS. 1b and 2b show a front view of a plant support structure in accordance with a second embodiment of the present disclosure.

FIGS. 3a and 3b show a perspective view of the plant support structure as shown in FIG. 1a.

FIG. 4 shows a further configuration of the plant support structure, according to a third embodiment of the present disclosure.

FIG. 5 shows a further configuration a plant support structure providing a window in the plant support structure, in accordance with a further embodiment of the present disclosure.

FIG. 6 shows an example of installation of plant support structures on different floors of a building.

FIG. 7 shows a plant support system comprising a plant support structure and various other components for support and growth of plants in the plant support structure.

FIG. 8a shows an arm of the plant support structure having hexagonal blocks and FIG. 8b shows an enlarged view.

FIG. 9 shows an exemplary plant support structure that is suspended as a building façade spanning multiple floors of the building.

FIG. 10 shows a channel of a plant support structure accommodating multiple plants and allowing integration of root balls of the plants throughout the channel.

FIGS. 11a-11c show portions various prototypes of the present plant support structure and associated system accommodating and supporting the growth of plants.

FIGS. 12a-12c and 13a-13c show various different configurations of the plant support structure when installed as a building façade and availability of different access points in these configurations for maintaining the structure.

FIGS. 14-18 show various configurations of a multi-layer plant support structure installed as a freestanding pavilion or partially supported pavilion.

FIGS. 19a-c show a plant support structure constructed from interconnecting elements having a micro-awning.

FIG. 20 shows a plant support structure assembled having a curve.

FIGS. 21a-b show example plant support structures having different configurations.

FIGS. 22a-b shows an example plant support structure that may be suitable for use with commercial buildings.

FIGS. 23a-b show an example plant support structure that may be suitable for use with residential buildings.

FIGS. 24a-c show a basin that can be incorporated into any one of the plant support structures disclosed herein.

FIGS. 25a-b show a nesting box that can be incorporated into any one of the plant support structures disclosed herein.

FIGS. 26a-c show an example plant support structure configured to incorporate different species and/or types of plants.

FIGS. 27a-b and 28 show an example plant support system and irrigation thereof.

FIGS. 29a-f show a variety of methods of incorporating plants into any one of the plant support structures disclosed herein.

FIG. 30 shows an example interconnecting element having a textured surface.

FIG. 31 shows an example of a plant support structure according to any one of the embodiments disclosed herein having a continuous habitat corridor for fauna.

FIG. 32 shows an example array of sensors that can be incorporated into any one of the plant support structures disclosed herein.

FIGS. 33a-b show alternative of methods of incorporating plants into any one of the plant support structures disclosed herein, similar to FIGS. 29a-d.

FIG. 34 shows an example plant support structure constructed as a fence.

FIG. 35a-c illustrate how any of the plant support structures disclosed herein can be assembled having curves of different radii.

FIG. 36 shows an example plant support structure having a different configuration.

FIG. 37 illustrates how porous material for plant growth may be incorporated into a plant support structure according to any of the embodiments disclosed herein.

FIG. 38 show an example plant support structure according to an embodiment and how porous material for plant growth may be incorporated into the plant support structure.

FIG. 39 show an example plant support system and irrigation thereof.

FIG. 40 shows an example method of growing plants on a roof disposed at angle.

FIG. 41 show another example plant support system and irrigation thereof.

FIG. 42 show another example plant support system and irrigation thereof.

### DETAILED DESCRIPTION

The systems disclosed herein relate to a plant support structure and a plant support system for accommodating and growing flora.

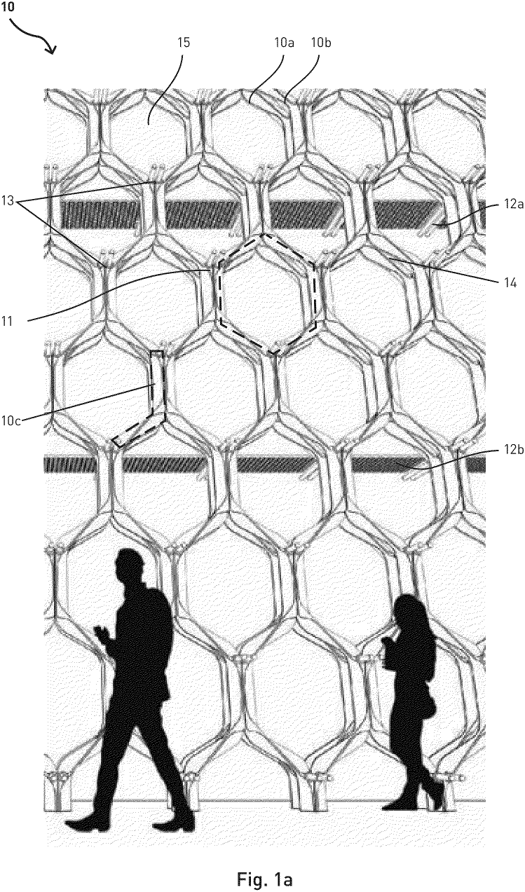

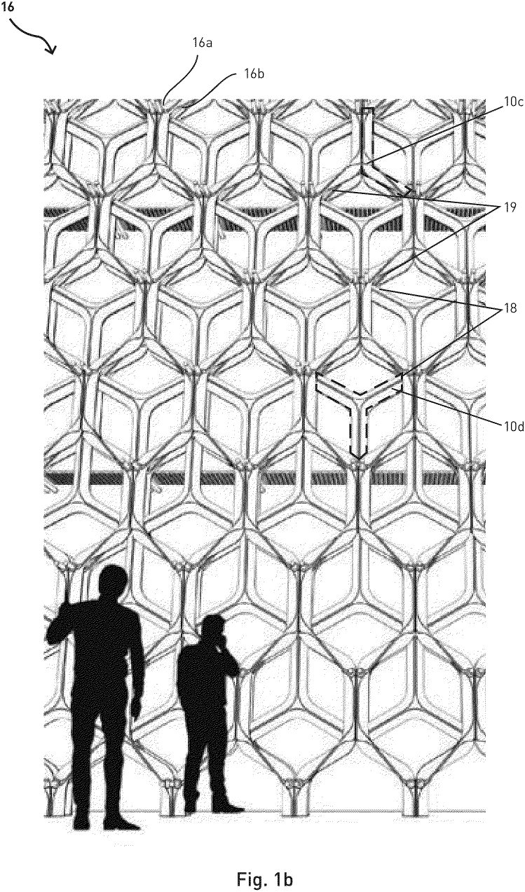

Referring now to FIG. 1a, there is shown a view of a plant support structure 10 in accordance with one embodiment of the present disclosure. For clarity of illustration, the view shown in FIG. 1a is referred to herein as a front view. It will be appreciated that the side designated front may differ between perspectives.

The plant support structure 10 includes a framework of primary interconnecting elements 10c interconnected to each other in a vertically extending arrangement to form the plant support structure 10. The interconnecting elements 10c form an interlaced hexagonal geometry that includes a plurality of geometric blocks 11. Forming the plant support structure 10 from primary interconnecting elements 10c allows relatively large-scale structures to be constructed. For example, as shown in FIG. 1a through comparison with the height of a person, the structure may be several metres or more in height, for example at least 3 metres, at least 5 metres, at least 10 metres, or more and have a width dimension of several meters, for example at least 3 metres, at least 5 metres, at least 10 metres, or more. Forming the plant support structure 10 from primary interconnecting elements 10c also allows the overall side and dimensions of the plant support structure 10 to match the required installation site as more or less primary interconnecting elements 10c are added to adjust the height and/or width of the overall structure.

The interconnecting elements 10c are assembled together using suitable connectors 13. The connectors 13 may be, for example, in the form of brackets, metal tubes or metal rods, which are capable of securely connecting primary interconnecting elements 10c together and assembling the plant support structure 10. The connectors 13 may be made of a suitable lightweight metal, for example, aluminium. Alternatively, the connectors 13 may be made of any suitable weather resistant material, for example, stainless steel.

As best seen in FIG. 1a, the assembled plant support structure 10 has a front layer 10a and a back layer 10b formed of primary interconnecting elements 10c. The front and back layers 10a and 10b are structurally interconnected. In the embodiments shown, the front and back layers 10a and 10b can be connected together at the time of installation via the connectors 13. Each of the two layers of structure 10 comprises a plurality of geometric blocks (e.g. blocks 11) of specific shape and configuration. In this embodiment, each block has a hexagonal geometry. As seen in FIG. 1a, each block 11 is hexagonal shaped and oriented with a vertex as its uppermost part.

The hexagonal blocks 11 of the front and back layers 10a and 10b, respectively, of plant support structure 10 form channels 14 defined between the front and back layers 10a and 10b. In particular, the channels 14 are formed between the periphery of the blocks 11 of the front layer 10 and the periphery of the blocks 11 of the back layer 10b.

As best seen in FIG. 1a, each channel 14 is open on two sides, continuously descends from the top to the bottom of the plant support structure 10, and forms a non-linear path along its length. The channels 14 also do not include any sections that extend substantially horizontally.

The channels 14 are configured to accommodate and support plants and carry dripping/flowing water to allow the growth of the plants within the structure 10. The channels 14 may also carry fertilisers and other fluids or materials, for example to implement a hydroponics system. The distance between the front and back layers 10a and 10b and accordingly the width of the channels 14 may vary between installations. By way of example, the channels 14 may range in width between about 10 cm and about 2 metres.

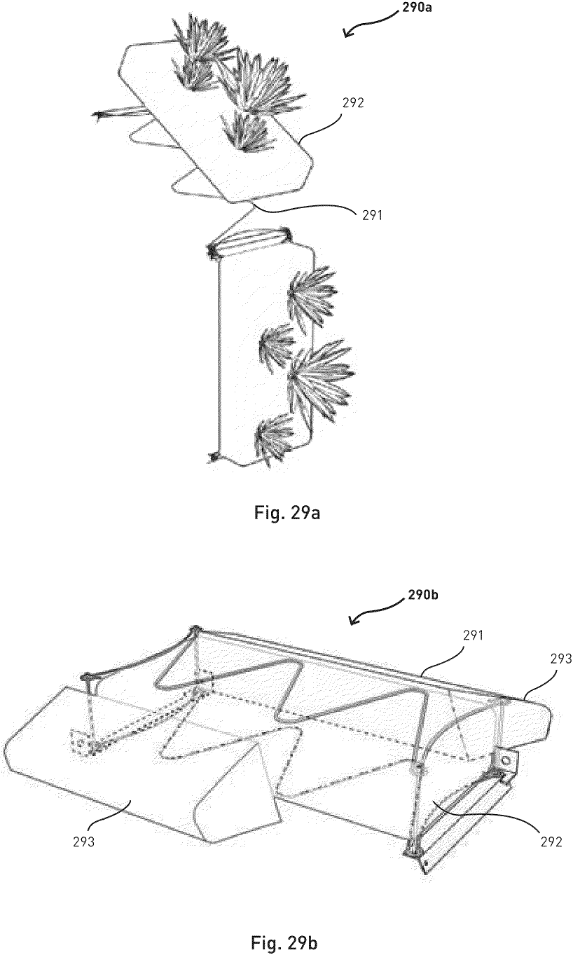

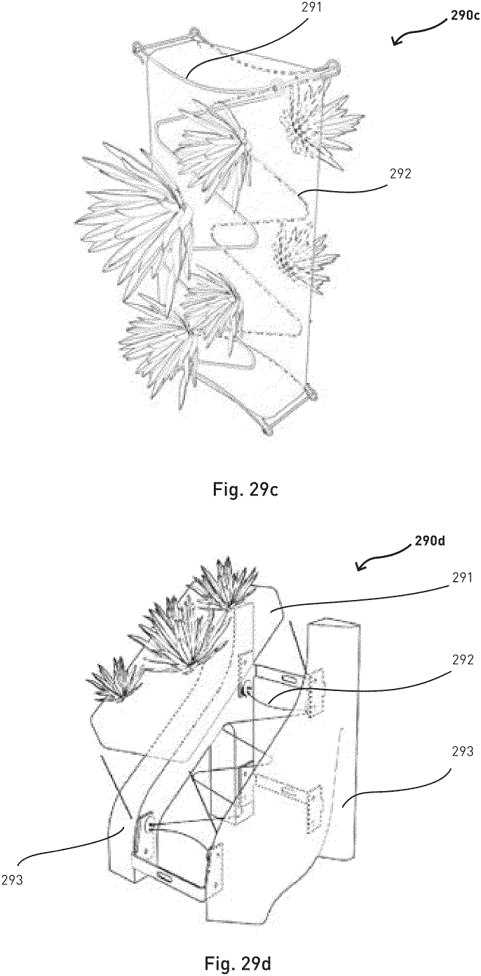

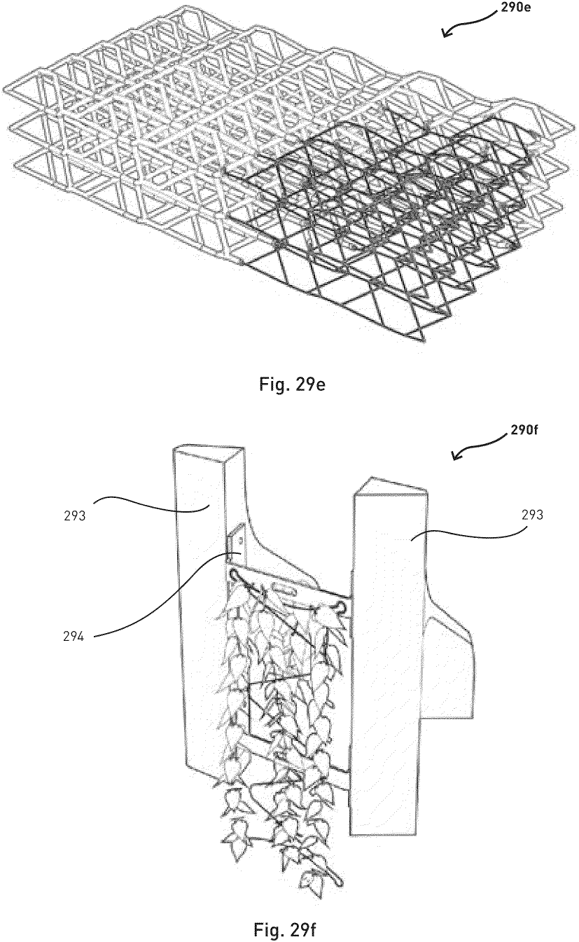

In some embodiments, the channels 14 receive and retain a porous material (see, for example, planting arrangements 290a-d in FIGS. 29a-d and latticework 290e in FIG. 29e described below), which may further help in accommodating and supporting plants, for example during early growth of the plants. For example, the porous material may be configured to accommodate and integrate roots of plants. The porous material may also regulate the water dripping/flowing through the channels. The porous material may be a wicking material or porous bag or lattice filled with a suitable medium to support plant growth. For example, the porous material may be a semi-permeable geotextile. Alternatively, the porous material may be formed as a lattice structure, for example, the latticework 290e illustrated in FIG. 29e (discussed below), which may be 3D printed having a variety of shapes and/or configurations.

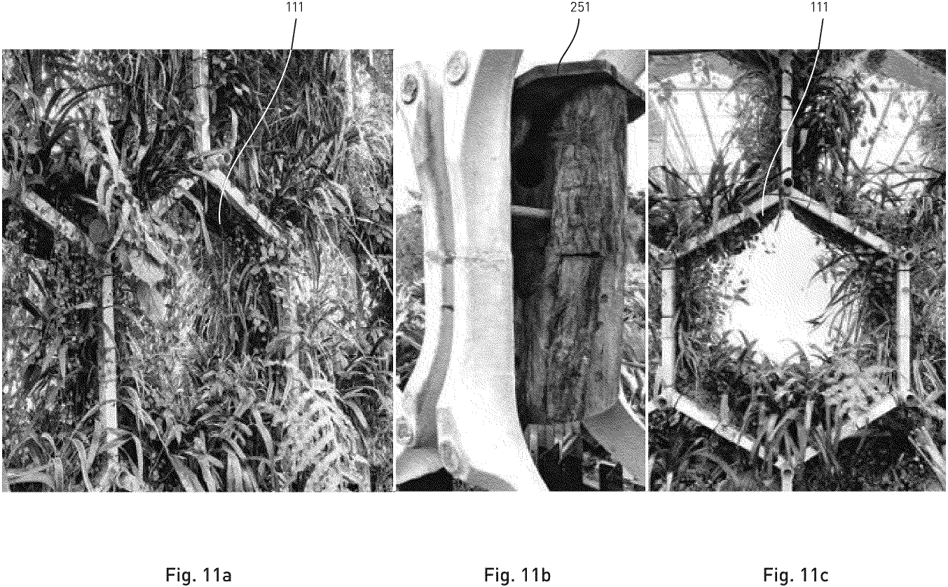

The porous material may be retained in place by netting, cage, or similar attached to the plant support structure 10 and extending between the front and back layers 10a and 10b to span the channels 14. For example, FIG. 11c shows porous material 111 retained between the front and back layers of the plant support structure using netting. Alternatively, the porous material may be integrally formed with netting or other reinforcing suitable for maintaining the porous material within the channels 14. The wider the channel 14, the more robust the netting or other structural support needs to be to hold the porous material in place within the channels 14.

In some embodiments, the plant support structure 10 is configured to be fastened to a wall 15 by support elements 12a. Support elements 12a may extend from the wall 15 to provide structural support for the plant support structure 10. In one embodiment, each support element 12a also forms the connector 13 for the primary interconnecting elements 10c at that location. For example, the support elements 12a may be rods or tubes extending from the wall 15 through the interconnecting elements 10c forming the front and back layers 10a and 10b. In some embodiments, at least one platform 12b is also provided, which is supported by one or more support elements 12a.

FIG. 1a shows two platforms 12b, each supported by a row of support elements 12a. The rows of support elements 12a are separated by at least a height to allow a person to traverse the platforms 12b. Accordingly, the platforms 12b allow access to the plant support structure 10, for example for structure and/or plant maintenance. The platforms 12b may be formed from durable perforated material and the support elements 12a may be formed from a plurality of stems formed from welded plates and/or steel sections projecting from mounting plates attached to the rear wall 15.

FIG. 1b shows a front view of a plant support structure 16 in accordance with another embodiment of the present disclosure. The plant support structure 16 is similar to the plant support structure 10 but has a different configuration. In this embodiment, the framework of the plant support structure 16 is denser than the plant support structure 10 of FIG. 1a. This denser framework allows less sunlight to pass through the plant support structure 16, therefore, allowing more shielding of the sunlight by the plant support structure 16. The denser plant support structure 16 also provides more surface area to accommodate more plants in the plant support structure 16 than in plant support structure 10. The plant support structure 16 is similar to plant support structure 10 except for incorporation of secondary interconnecting elements 10d. The secondary interconnecting elements 10d may be Y-shaped elements.

The plant support structure 16 also has two layers 16a and 16b (similar to front and back layers 10a and 10b of plant support structure 10 of FIG. 1a) overlaying on one another and connected together using connectors 18 (similar to connectors 13). The two layers 16a and 16b form channels 19 there between, which are configured to accommodate and support plants and carry dripping/flowing water to allow the growth of plants within the plant support structure 16. In this embodiment, the channels 19 are formed in part by the secondary interconnecting elements 10d, increasing the number of vertical paths through the plant support structure 16 in comparison to the plant support structure 10.

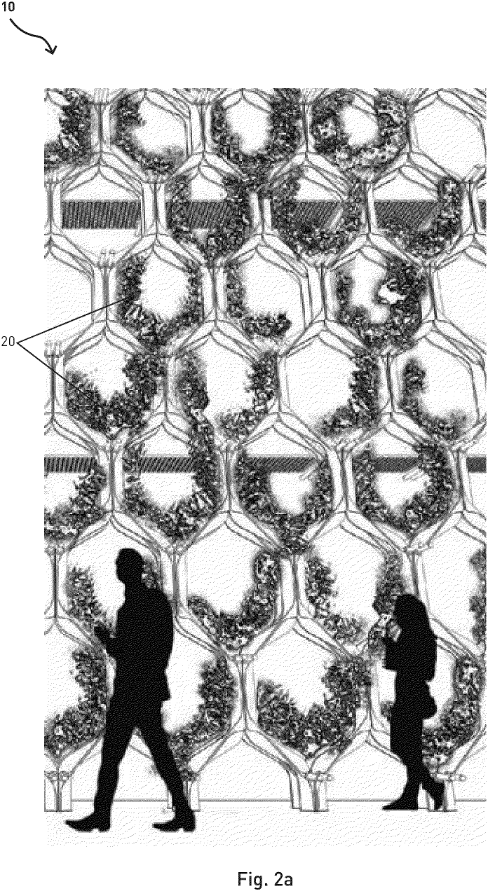

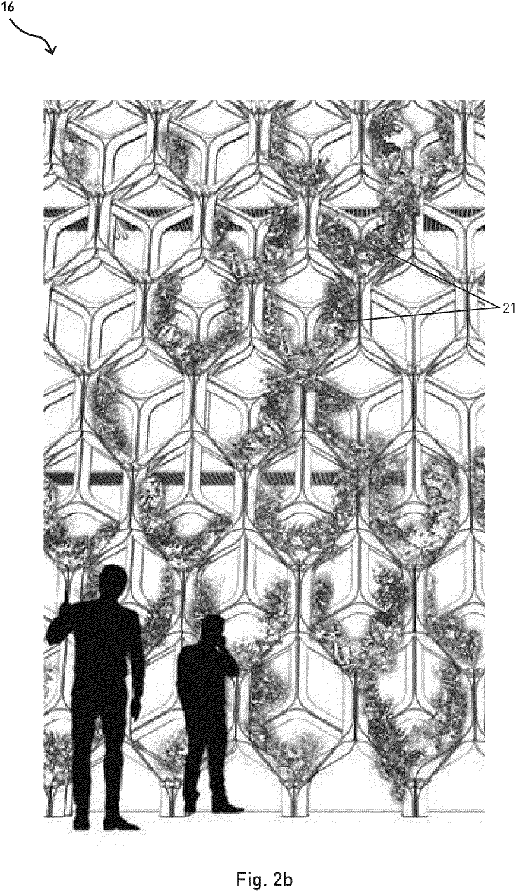

FIGS. 2a and 2b show a front view of the plant support structures 10 and 16, respectively. Each of the plant support structures 10 and 16 have a plurality of plants 20 and 21, respectively, supported in the channels 14 and 19, respectively. The plants 20 and 21 may directly be supported by the channels 14 and 19 or by porous material disposed in the channels 14 and 19.

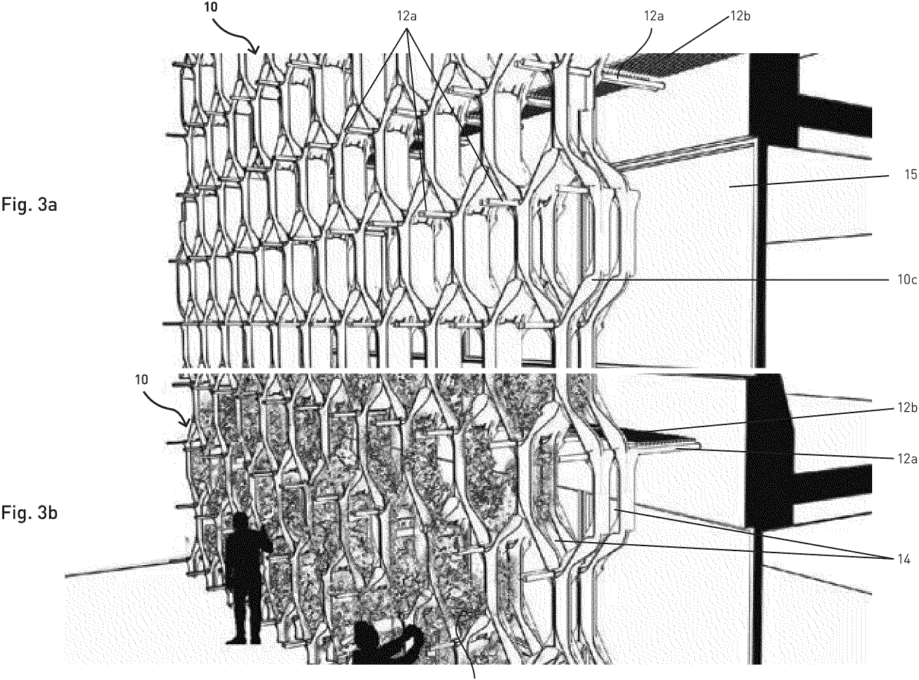

FIGS. 3a and 3b show a perspective view of structure 10 shown in FIGS. 1a and 2a, respectively. FIG. 3a shows a perspective view the structure 10 without plants and FIG. 3b shows a perspective view of the structure 10 with plants. The plant support structure 10 is secured to the rear wall 15 using support elements 12a and includes platforms 12b supported by respective support elements. Connectors 13 are provided to connect primary interconnect elements 10c together between support elements 12a.

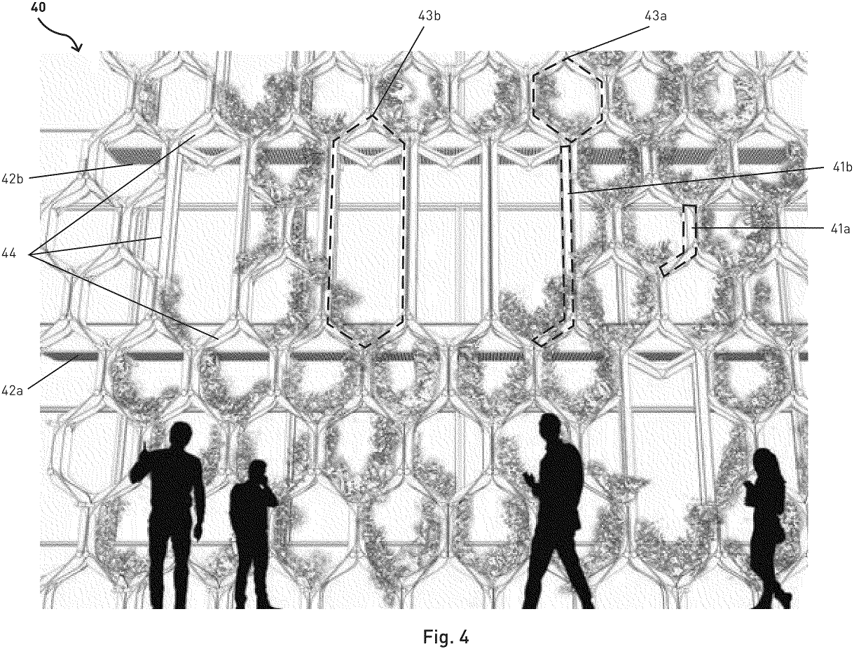

FIG. 4 shows a plant support structure 40 according to a third embodiment of the present disclosure. The plant support structure 40 is less dense in comparison to each of plant support structures 10 and 16 of FIGS. 1a and 1b. As evident from FIG. 4, the plant support structure 40 includes two different types of primary interconnecting elements 41a and 41b. The interconnecting elements 41b are longer than the interconnecting element 41b. Compared to plant support structures 10 and 16, the assembly of these primary interconnecting elements 41a and 41b provides a less dense plant support structure 40, which has regular hexagonal blocks 43a and elongated hexagonal blocks 43b. Similar to the plant support structures 10 and 16, plant support structure 40 has a front layer 40a and a back layer 40b formed by the primary interconnecting elements 41a and 41b. The front and back layers 40a and 40b form channels 44 there between similar to plant support structures 10 and 16. Other components such as connectors and support elements of plant support structure 40 are the same as discussed above for plant support structures 10 and 16.

Compared to plant support structures 10 and 16, the plant support structure 40 allows more sunlight to pass through, especially through the elongated hexagonal blocks 43b. In an example application, the plant support structure 40 may be configured to place elongated hexagonal blocks 43b adjacent to a window, balcony, or other location where increased sight through the plant support structure 40 is required or desired. As shown in FIG. 4, a method of installation may include omitting plants at the elongated hexagonal blocks 43b. Porous material in the channels 44 around the elongated hexagonal blocks 43b may also be omitted.

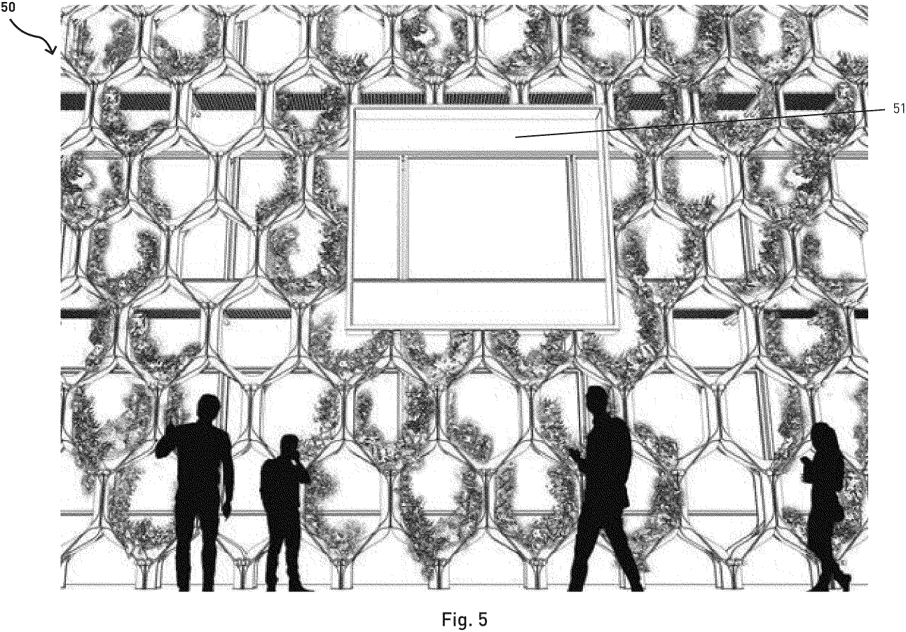

FIG. 5 shows a plant support structure 50 in accordance with a further embodiment of the present disclosure. The plant support structure 50 is similar to the plant support structure 10 show in FIGS. 1a and 2a except for the incorporation of a window 51 within the plant support structure 50. One or more windows 51 may be incorporated in the plant support structure 50. These windows 51 allow direct access to sunlight and fresh air from within the building (e.g. if the plant support structure 50 is used as a building façade to cover up one or more faces of a building) without having the obstruction of interconnecting elements (e.g. any of the interconnecting element disclosed herein).

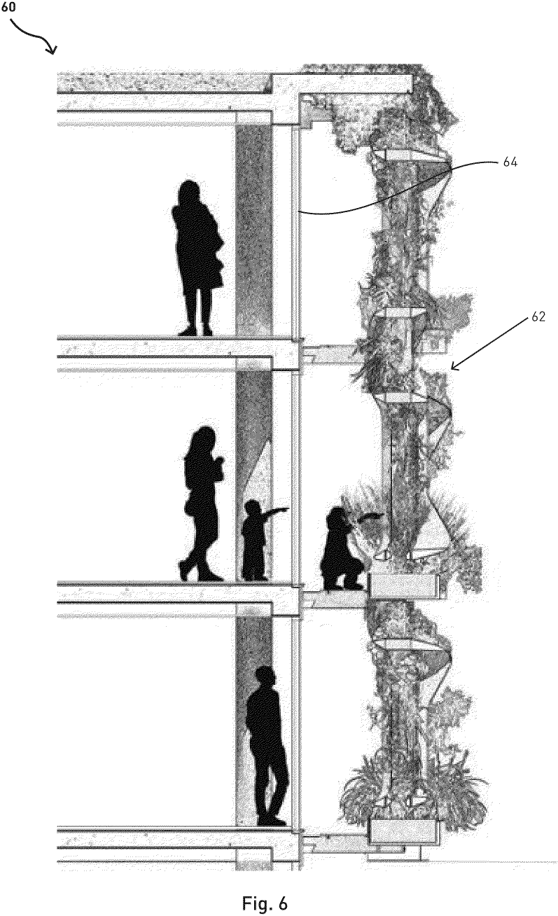

FIG. 6 shows a cross-section of a building 60 having a plurality of floors. A front face 64 of the building 60 predominantly faces the sunrays for the majority of the day. A plant support structure 61 is shown as being installed in front of each of the floors of the building 60 near the front face 64 of the building 60. The plant support structure 61 is shown installed as a front façade for the building 60. It is also envisaged that the plant support structure 60 may be installed as rear or side façade for the building 60. The plant support structure 60 may be assembled according to any of the plant support structures disclosed herein.

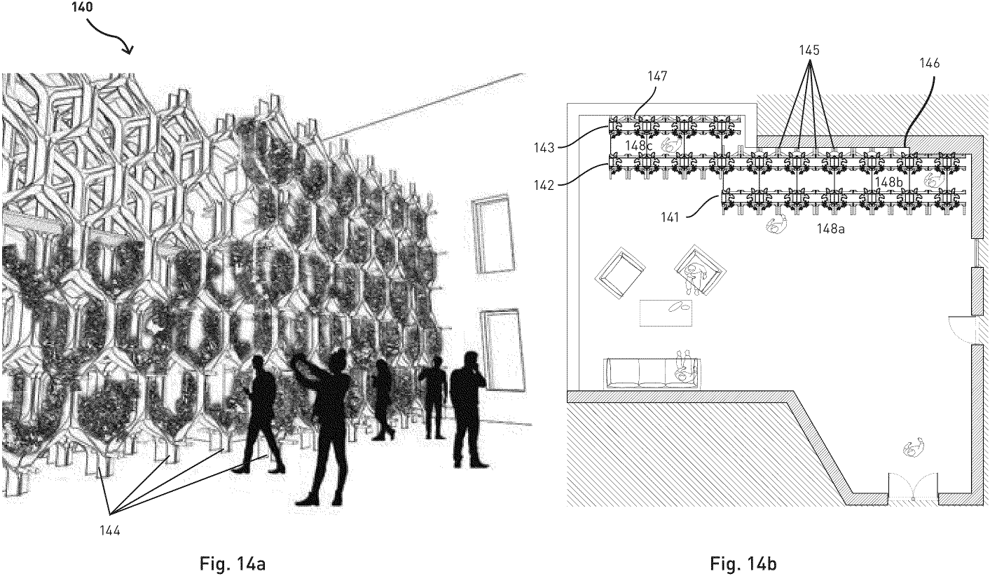

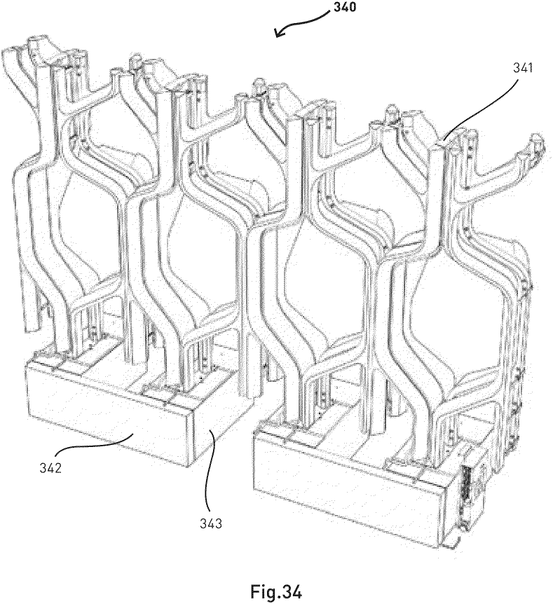

The plant support structure can be in the form of a building façade, a freestanding pavilion (for example, as illustrated in FIGS. 14 - 18), or a fence (for example, as illustrated in FIG. 34). In embodiments in which the plant support structure acts as a building façade structure for an external face of a building, primary interconnecting elements are connected together to form a plant structure that spans the external face of the building and is anchored to the support elements/concrete slabs or similar of the building (e.g. as shown in FIGS. 1a, 1b, 2a, 2b, 3a, 3b, 4 and 5). In an alternative embodiment, in which the plant support structure is a freestanding pavilion or fence, the primary interconnecting elements may be supported by concrete block foundations or water tanks (e.g. see FIG. 34) disposed within, partially within, or on the ground.

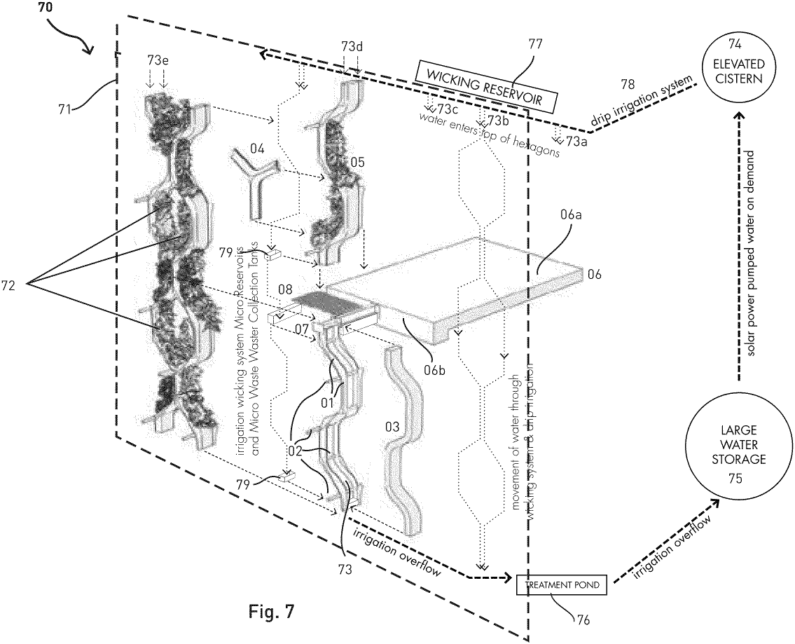

Referring now to FIG. 7, there is shown a plant support system 70 comprising a plant support structure 71 and components of a water supply system. The plant support structure is only partially illustrated for clarity of illustration. The water supply system components include a drip irrigation system 78, a reservoir 77, an elevated cistern 74, a water storage tank 75, and a water treatment pond 76. The plant support structure 71 may be any one of the plant support structures disclosed herein.

In FIG. 7, an exploded view of the plant support system 70 is shown to elucidate an embodiment of how various parts of the plant support structure 71 may be assembled and secured together. It will be appreciated that there are various alternative methods of assembling and securing the components in place.

The plant support structure 71 comprises primary interconnecting elements 01. The primary interconnecting elements 01 may include any of the primary connecting elements disclosed herein. The primary interconnecting elements 01 are connected together using connectors (e.g. connectors 13 and 18 described above) such as brackets, metal tubes or metal rods to form a framework of the plant support structure 71. In this embodiment, the connectors are formed from aluminium tubes 02. The plant support structure 71 has a plurality of blocks 72 similar to blocks 11, 43a, and 43b described above. In this embodiment, the blocks 72 are shown to have hexagonal geometry.

The assembly of various primary interconnecting elements 01 provides a plant support structure 71 that has channels 73a-e that run from the top to bottom of the plant support structure 71. The channels 73a-e are configured to accommodate and support plants and carry dripping/flowing water to allow the growth of the plants within the structure 71. Water enters the system at the top of the geometric shapes (e.g. hexagons), through these channels 73a-e. The channels 73a-e may also carry fertilisers and other fluids or materials, if required. In an embodiment, the channels 73a-e may receive a porous material 03 that further helps in accommodating and supporting plants and allows for a more controlled water dripping/flow through the channel 73. The channels 73a-e can independently function to support plants 05 and allow water dripping/flowing from the top to bottom of the plant support structure 71 without the use of the porous material 03.

In an embodiment, the porous material 03 may be a continuous single body that fits into the channels 73a-e along a plurality of interconnecting elements 01, up to the entire height of the plant support structure 71 (if there is no obstruction within the channels 73-e as shown in FIG. 7). In an alternative embodiment, the porous material 03 is provided as multiple smaller sized pieces that are disposed into the channels 73a-e along the height of the plant support structure 71.

Secondary interconnecting elements 04 (e.g. interconnecting elements 10d describe above) may also be connected to the primary interconnecting elements 01 to provide a more dense plant support structure 71. In some embodiments, the secondary interconnecting elements 04 are configured to provide additional functionality, for example by incorporating nesting boxes, boxes, hives, insect nests, or basins shaped as baths, for fauna such as birds. Incorporation of secondary interconnecting elements 04 in the plant support structure 71 may be omitted in parts or all of the plant support structure 71. In some embodiments, the additional functionality may also be provided by structures on one or more of the primary interconnecting elements 01.

The plant support system 70 further includes or is connected to one or more support elements 06 for supporting the plant support structure 71. In an embodiment, each support element 06 is a concrete slab that is secured to or forms part of a building/wall/other structure at its rear face 06a. A fastener 07 (e.g. support elements 12a described above) secures the plant support structure 71 to the support element/concrete slab 06 at its front face 06b. In this way, the plant support structure 71 is held in place in an upright position. One or more support elements 06 may be used based on the size of the plant support structure 71.

In an embodiment, a maintenance platform 08 (e.g. platforms 12b described above) is secured to the concrete slab 06 and supported by fasteners 07. The maintenance platform 08 may provide access to maintenance personnel to the plant support structure 71, to enable structure and/or plant maintenance. Stairs, ladders or similar (not shown) may be provided between platforms 08 to provide an additional exit from a structure attached to or by the plant support system 70. Where the structure is a building, these may provide, for example, a fire escape from the building.

The plant support structure 71 is configured to receive water from a drip irrigation system 78 provided with a reservoir 77. The reservoir 77 is connected to the channels 73a-73e at the top most end of the plant support structure 71. Water enters the channels 73a-e (for example, via the drip irrigation system 78 or reservoirs 275 discussed below) and moves down through the channels 73a-e. In some embodiments, the reservoir 77 is fitted with a wicking material to regulate and/or distribute the water into and across the channels 73a-e of the plant support structure 71, or through the porous material 03. In embodiments, where a porous material 03 is placed within one or more of the channels 73a-e, a more controlled flow of water from the top to the bottom of the plant support structure 71 may be provided.

During irrigation of plants in the plant support structure 71, some overflow of water might take place, which can be collected in the water treatment pond 76 that is provided near the bottom end of the plant support structure 71. In an example, the porous material 03 may be formed of a plurality of porous materials, each having a water collector 79 configured to collect water during irrigation. Some of the overflow water may be collected in the water collector 79 of each porous material 03. Excess water in the water collector 79 of each porous material 03 may subsequently be collected in the water treatment pond 76.

After water treatment at the water treatment pond 76, the treated water can be moved to a water storage tank 75. The treated water can then be pumped into an elevated cistern 74 that is located at a height above the top edge of the structure 71. The system 70 may also include a solar power system (not shown) that can produce sufficient solar power to pump the treated water into the elevated cistern 74. The drip irrigation system 78 takes water from the elevated cistern 74 and/or from the reservoirs 77 and provides it to the channels 73a-73e. The plant support system 70 may also be coupled in fluid communication to an external water supply (e.g. mains water). The external water supply may provide water to the plant support system 70, for example to the cistern 74 or to the water storage tank 75.

The plant support system 70 of the present disclosure is a system that may mimic, to some extent, the complex ecosystem of forests to support plant growth and thus provide an “artificial” habitat for insects, reptiles, birds and other fauna. Therefore, these systems may also help address the issues of rapidly decreasing biodiversity in urban areas.

The plant support structures and plant support systems disclosed herein may have multiple applications as a retro-fittable building façade, freestanding pavilion/wall, or fence within or outside buildings, houses, and other real estate infrastructure.

Installation and operation of the plant support structures and plant support systems disclosed herein may allow buildings to cool down naturally and therefore reduce the cost of artificial cooling using air-conditioning and fans. Therefore, these systems may reduce the cost of operating a building with a reduction in the need for artificial cooling by reducing the heat load on the building. A well-ventilated plant support structure may cool down naturally, further reducing the heat load from radiation and/or reflected ambient heat.

The plant support structures and systems disclosed herein may also help in reducing heat island effect in congested city areas with multiple buildings and concrete infrastructure. These systems may reduce the heat island effect by shielding the thermal mass of buildings with a well ventilated plant support structure accommodating a variety of plants. The vegetation within the plant support structures provide a living shield. This may further reduce the heat gain, to the building, the building façade, and the surrounding built environment. The vegetation both shades as well as absorbs the sun radiation and heat energy.

Furthermore, the growing vegetation allows for the absorption of CO₂ and other harmful gases from the environment. The plant support structures disclosed herein may have a large plant surface area in a substantially vertical direction. Therefore, air purification may be achieved in a spatially efficient way.

Water flow through the plant support structures disclosed herein is facilitated by the block configuration (e.g. blocks 11, 43a, and 43b). For example, as shown in embodiments in FIGS. 1-5 and 7, each of the plurality of blocks of the plant support structure (e.g. plant support structures 10, 16, 40, and 50) has a hexagonal shape (and/or an elongated hexagonal as in FIG. 4). The hexagonal shape is effective to allow a regular flow of water through the hexagonal blocks. The channels (e.g. channels 14, 19, and 44) of the hexagonal blocks have arms which are either vertically oriented or slanting but not horizontally oriented. The absence of or minimisation of horizontal flow paths allows an efficient and regular flow of water from the top to bottom of the plant support structure, while the slanting sections allow for horizontal distribution of water. The action of gravity assists to ensure water flow, acting as a form of pump for the water through the channels. This also helps in an efficient growth of plants because the roots of the plants are not drenched in excess water. It will be appreciated that the path water traverses includes but is not confined to the channels. Some water may traverse through the channels of a block, while other water will drip from the top slanting sections of the block onto the bottom slanting sections.

The plant support structures and plant support systems disclosed herein may be installed, for example, on the northern façade of a building (e.g. for buildings in the southern hemisphere) or on the southern façade (e.g. for buildings in the northern hemisphere). However, the plant support structures disclosed herein may be installed on any façade of a building. Installation of the structure may improve building system performance and efficiency, for example with respect to the operation of air conditioning systems and/or the reduction or elimination of incoming glare.

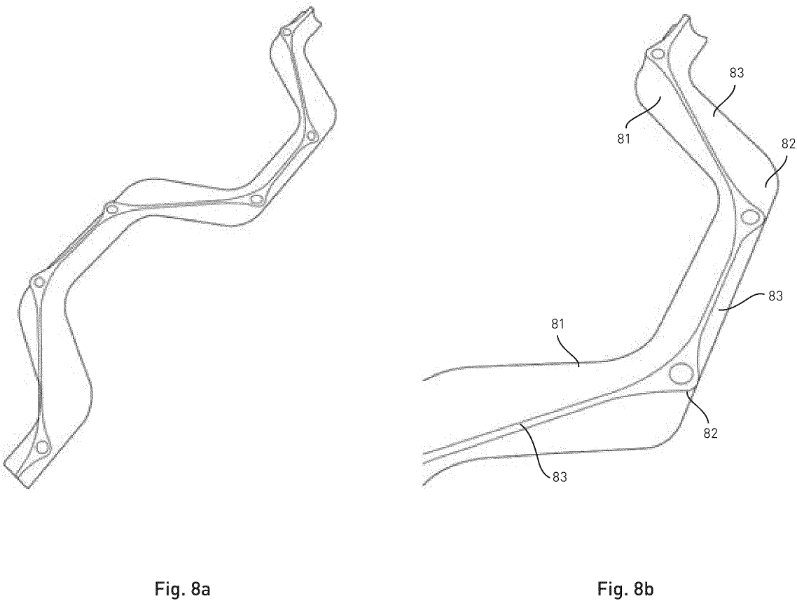

FIG. 8a shows part of the plant support structure having hexagonal blocks. FIG. 8b shows an enlarged view of a portion of FIG. 8a. The structure has material 81 removed on the inner side of the hexagonal block and material 82 removed on the outer side of the hexagonal block. By material removed, it is meant that the cross-sectional shape occupies less area in comparison to other areas, which may have been formed during original fabrication (e.g. in a mould) or formed after original fabrication (e.g. by cutting away sections of the block, which parts are preferably re-used). The removal of material may lighten the structure and may result in material savings. A mid-section 83 of the structure has a relatively large cross-sectional area. As shown, the mid-section 83 may include within its bounds a line of increased thickness with a curved profile, which does not include discontinuities. The mid-section may maintain or substantially maintain the load carrying capability of the hexagonal structure, including having regard to the lighter load presented by blocks above due to the removal of material.

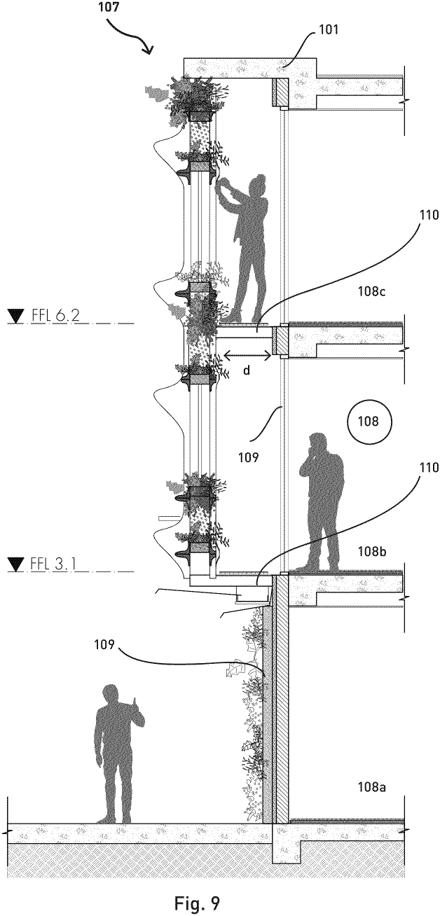

An example configuration of a plant support structure 107 according the present disclosure relative to building structure 101 is shown in FIG. 9. The plant support structure 107 may be any one of plant support structures disclosed herein. The plant support structure 107 is installed in front of floors 108b-c. Installed below the plant support structure 107 on floor 108a is a green wall 112.

In FIG. 9, the plant support structure 107 is spaced away from building 101 allowing the building 101 to be better ventilated, preventing moisture and mould on the surface of the building 101. For example, in FIG. 9, the plant support structure 107 is spaced at a distance “d” from a balcony door or glazing 109 of floors 108b-c of the building 101. Therefore, the plant support structure 107 overall may require less maintenance in comparison to conventional systems. The space between the plant support structure 107 and the building 101 may be used to accommodate maintenance platforms 110 (e.g. platforms 12b described above). FIG. 9 shows a person utilising a maintenance platform 110 on the floor indicated 108c. Platforms 110 can be provided at floors 108b-c. The maintenance platforms 110 may be vertically spaced to allow a person to traverse between them. Further, stairs or ladders may be provided between maintenance platforms, which may provide a fire escape for the plant support structure 107 and/or the building 101. The plant support structure 107 may also integrate fire sprinkler systems (not shown) to douse fires related to the building 101, and or the plant support structure, and or green roof of the building 101.

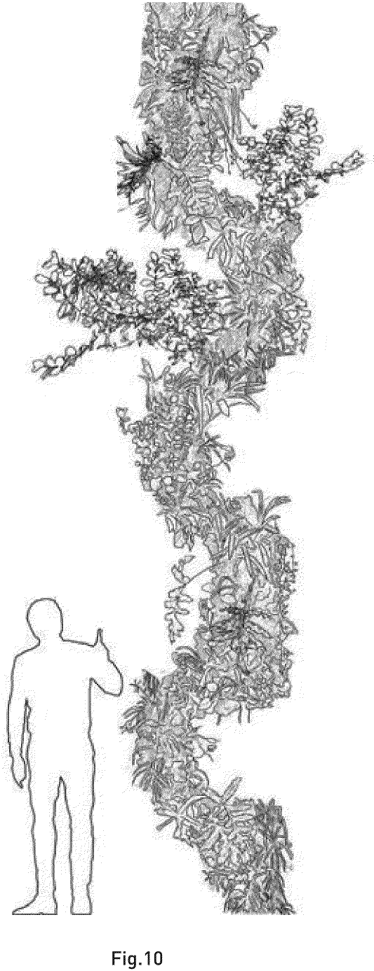

The channels (e.g. channels 14, 19, and 44 described above) and/or the porous material (e.g. planting arrangements 290a-d and lattice work 293 described below) in the channels allow for the integration of the root balls of plants throughout the plant support structure (e.g. plant support structures 10, 16, 40, and 50) as shown in FIG. 10. The integration of the root balls may provide more robust vegetation, in comparison to green walls formed from a collection of plastic pot plant containers assembled into a building wall.

FIGS. 11a-11c show photographs of portions of prototypes of plant support systems constructed according to embodiments disclosed herein. These prototypes are shown as accommodating and supporting the growth of plants. As best seen in FIGS. 11a and 11c, porous material 111 (e.g. planting arrangements 290a-d and/or lattice work 293 described below) is disposed in the channels of the prototype plant support systems.

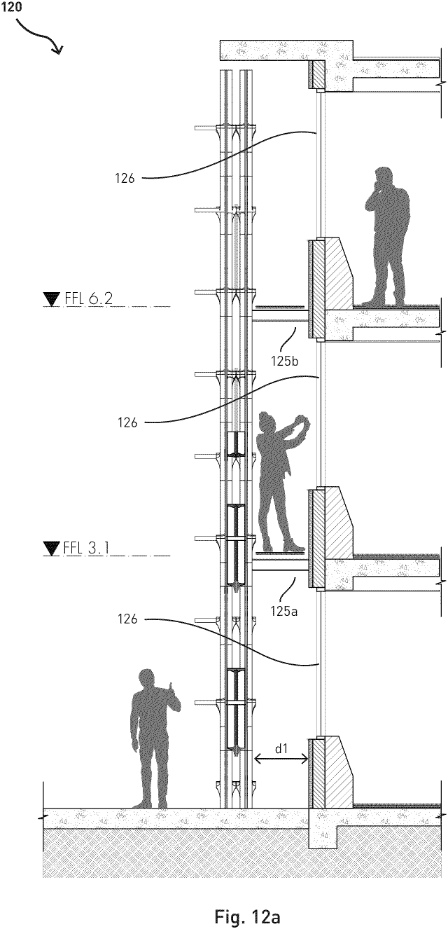

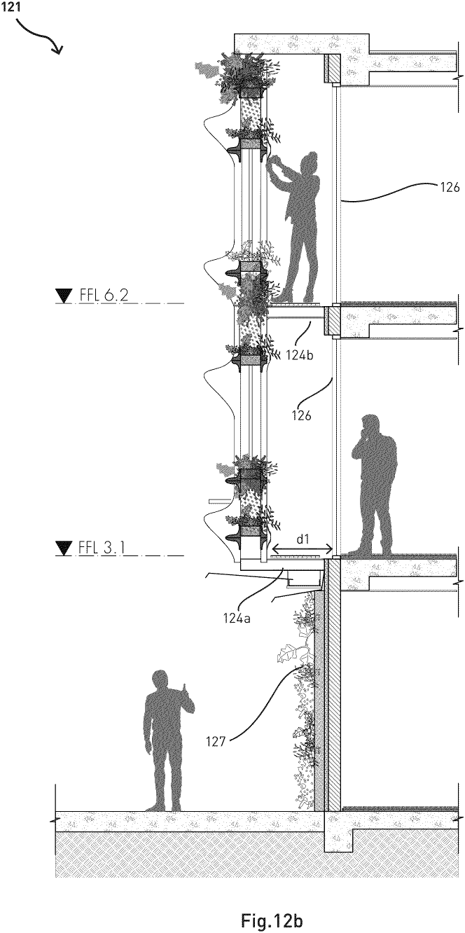

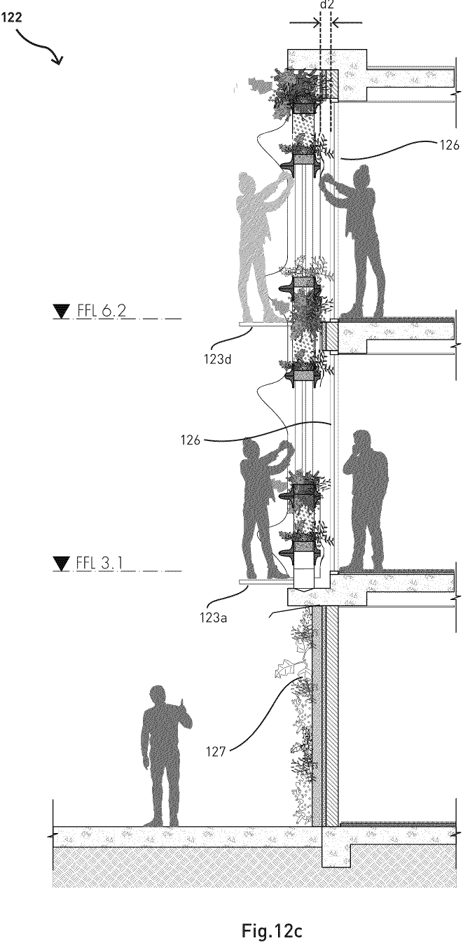

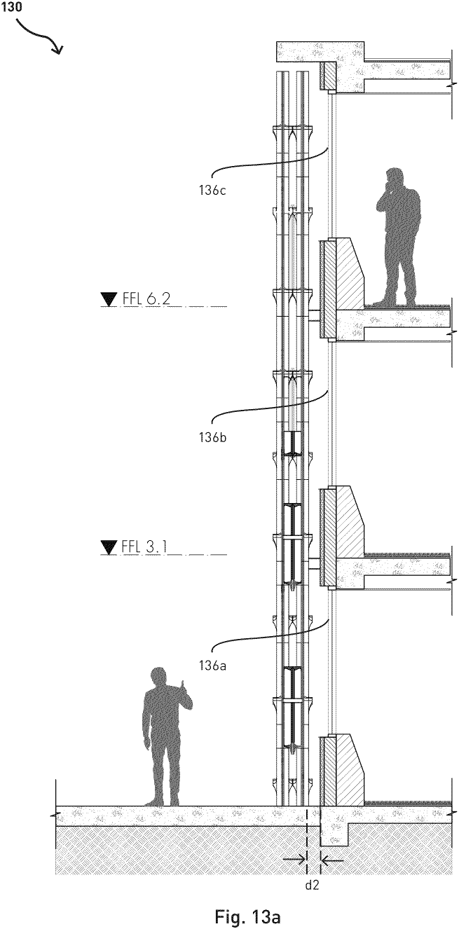

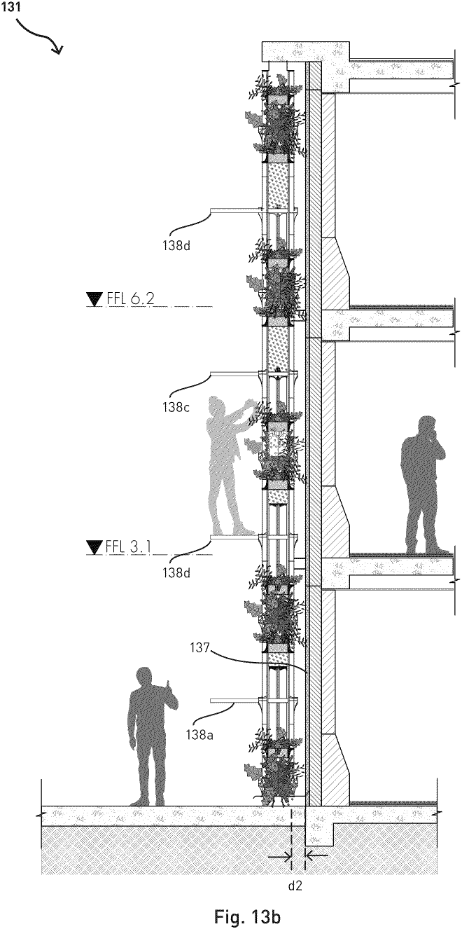

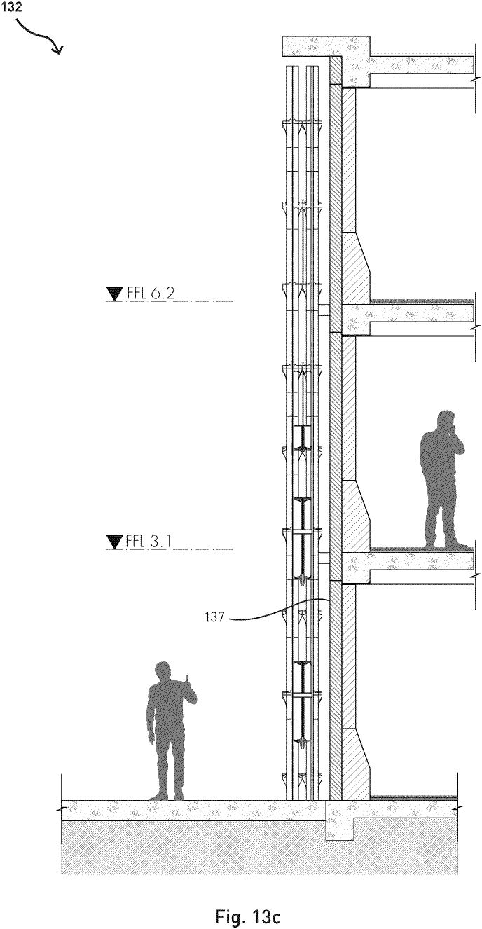

FIGS. 12a-12c and 13a-13c show various different configurations of plant supports structure when installed as a building façade and availability of different access points in these configurations for maintaining the structure. FIGS. 12a and 13a-c show plant support structures that span over three floors of a building. FIGS. 12b and 12c show plant support structures that span the first and second floors of a building and a green wall 127 installed on the ground floor of the building below the plant support stuctures. The plant support structures illustrated in these figures may be any one of plant support structures disclosed herein.

FIG. 12a shows a plant support structure 120 without plants whereas FIG. 12b shows a plant support structure 121 with plants. The plant support structures 120 and 121 in FIGS. 12a and 12b are spaced at a distance d₁ from a balcony door 126 on each floor of the building, thereby allowing access for maintenance from inside the buildings using respective platforms 124a-b and 125a-b. With respect to FIG. 12c, the plant support structure 120 may also be accessed through the balcony door 126 of the first and second floors, or any floors where the system is spaced from the building.

The plant support structure 122 in FIG. 12c is spaced from the building at a distance d₂ from the balcony doors 126 of each floor of the building. The distance d₂ being smaller than distance d₁. The plant support structure 122 is designed to have one or more platforms 123a and 123d that a user can utilize to access the plant support structure 122 for maintaining the plant support structure 122.

FIGS. 13a-13c show plant support structures 130, 131, and 132, respectively, each of which is disposed close to the building (i.e. at a distance d₂). The plant support structure 130 in FIG. 13a is accessible for maintenance from inside the building through the access areas 136a-136c, which may for example be openings, windows, or balconies. The plant support structure 130 is not provided with any external platforms like those provided in FIGS. 12c and 13b.

The plant support structure 131 in FIG. 13b is spaced at a distance d₂ from the building wall 137. Therefore, no access for maintenance is available from inside the building. The structure 131 is, however, provided with external maintenance platforms 138a-138d (e.g. platforms 12b described above).

FIG. 13c shows a plant support structure 132 that does not have any external or internal access points for maintenance. The plant support structure 132 may omit the porous material, plants, and irrigation systems, instead only providing a particular aesthetic appearance from the structure 132 itself. Maintenance mechanisms may be provided separately, for example through use of a mobile elevated platform or a crane.

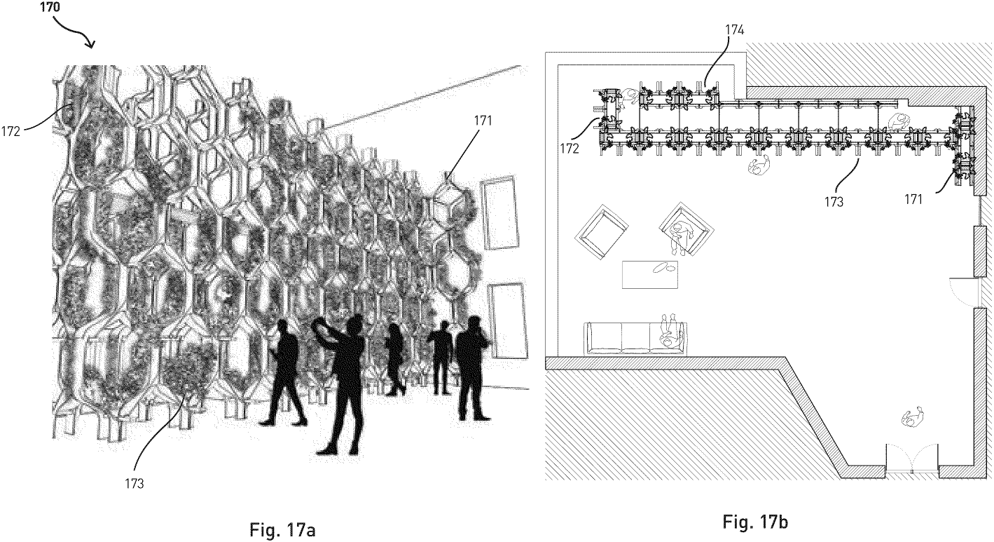

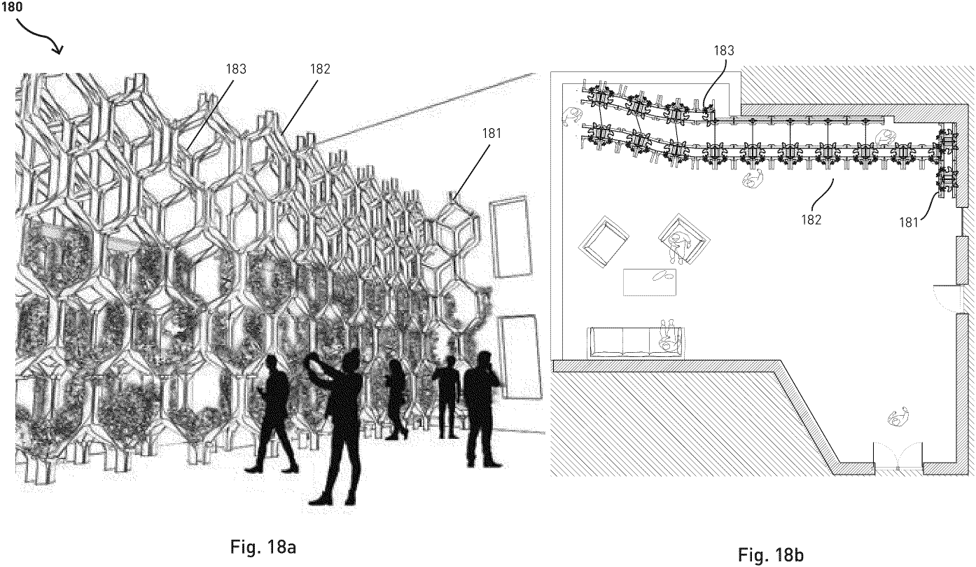

FIGS. 14-18 show various configurations of a multi-layer plant support structure installed as a freestanding pavilion/wall or partially supported pavilion/wall.

FIG. 14a shows a perspective view of a plant support installation 140 and FIG. 14b shows a schematic top view of the plant support installation 140 of FIG. 14a. The plant support installation 140 has three structures 141, 142, and 143 (evident in FIG. 14b). The first structure 141 is a freestanding pavilion/wall that is secured in place by anchoring it to the ground at points 144. The second and third structures 142, 143 are secured to the ground in a similar fashion as structure 141 however these structures 142, 143 are also secured to respective walls 146, 147 by connections 145 and 147, respectively. Two or more of the structures may be connected to each other, for example by support elements 12a previously described (not shown in FIGS. 14a, 14b), which may be located above head height so as not to impede ground access to the spaces between the structures. There are multiple access points 148a-148c for maintenance of the installation 140.

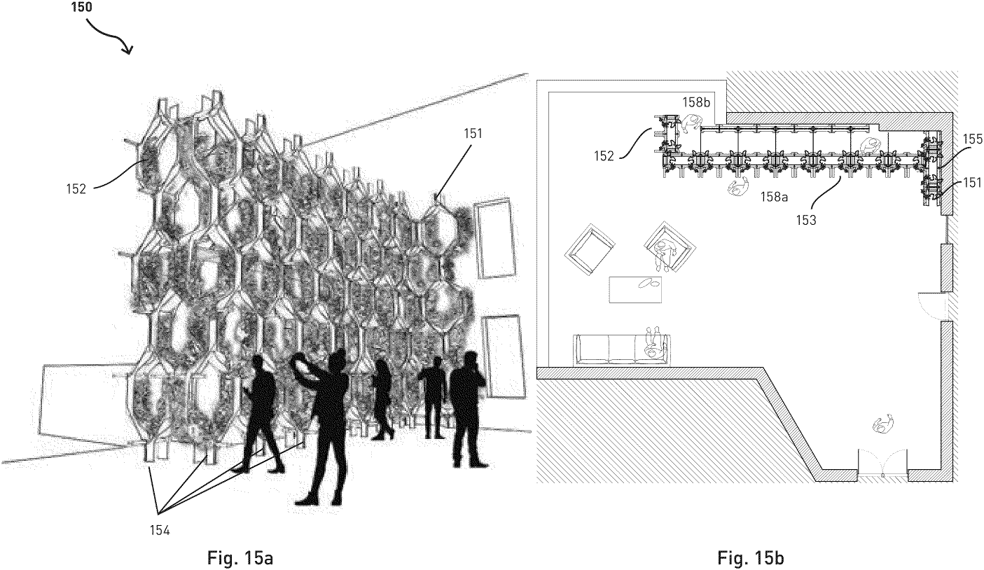

FIG. 15a shows a perspective view of a plant support installation 150 and FIG. 15b shows a schematic top view of the plant support installation 150 of FIG. 15a. The plant support installation 150 comprises a single structure having three sections 151, 152, and 153 (evident in FIG. 15b) connected to one another. The section 151 is standing against a sidewall 155. The sections 151-153 are secured in place by anchoring these to the ground at points 154 and may also be secured by support elements 12a. There are two access points 158a-158b (front and back access points) for maintenance of the plant support installation 150.

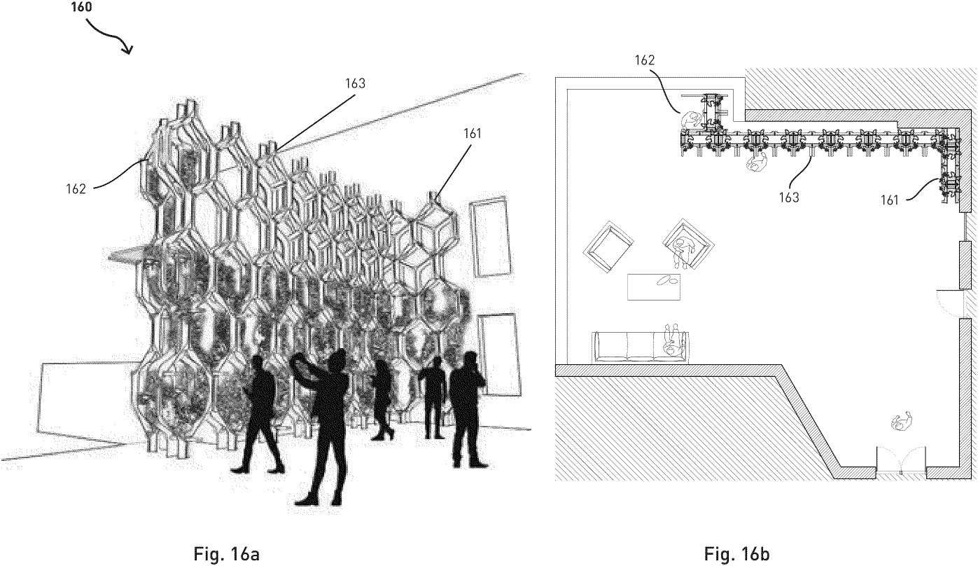

FIGS. 16a, 17a and 18a are perspective views of plant support installations 160, 170, and 180, respectively. Each plant support installation has structures 161-163, 171-174, and 181-183, respectively. FIGS. 16b, 17b, and 18b show schematic top views of the plant support installations of FIGS. 16a, 17a and 18a, respectively. The plant support installations 160-180 have slightly different configurations.

It will be appreciated that other embodiments will include variations from the embodiments described herein above and shown in the accompanying figures.

For example, the primary interconnecting elements 10c may form more or less of the structure. While in FIG. 1a each primary interconnecting element 10c has two arms at an obtuse angel to form one-third of a hexagon shape, in other embodiments the primary interconnecting element 10c may have a different length. In some embodiments, the length is selected so that a plant support structure can be formed from like interconnecting elements (e.g. interconnecting elements 10c, 10d, 41b, and 43b). For example, with reference to the hexagonal shaped block 11 of FIG. 1a, a length of four arms allows the block 11 to be formed. In one form, a four-arm length element includes the two arms of interconnecting element 10c plus two arms above or below (or equivalently one arm above and one below). In another form, a four-arm length element includes half of each of a pair of the vertically extending arms and the three arms around one side of the hexagon shape. In other embodiments the interconnecting elements have two or more different shapes that interconnect to form the structure.

In another example, it is also envisaged that a plant support structure according to embodiments disclosed herein may have three or more layers formed from interconnecting elements (e.g. interconnecting elements 10c, 10d, 41b, and 43b). The layers may be formed during manufacture of the interconnecting elements, or formed on site at the time of installation to form the structure. In the example of three layers, two adjacent channels similar to channels 14 may be provided, one channel formed between the front and middle layer and another channel formed between the middle and back layer.

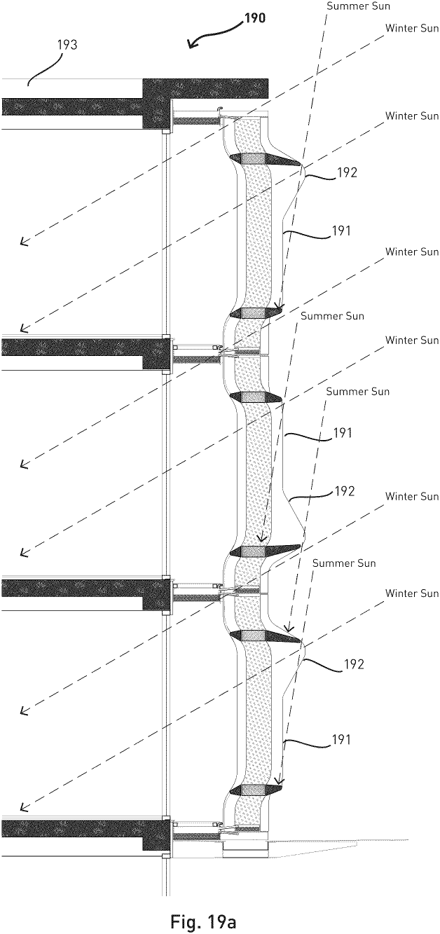

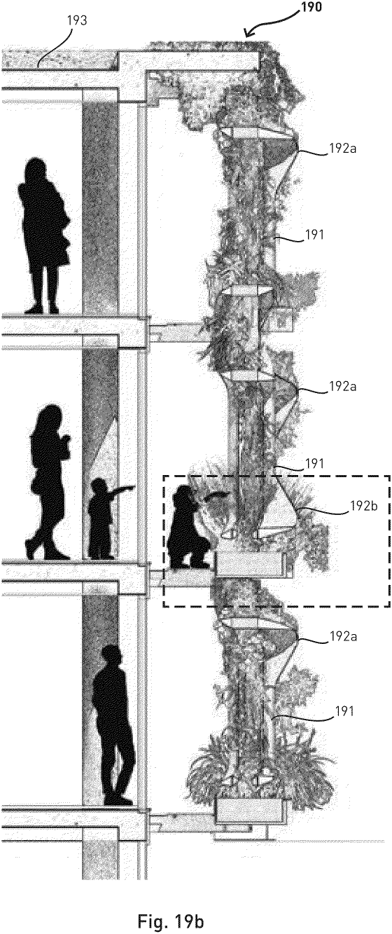

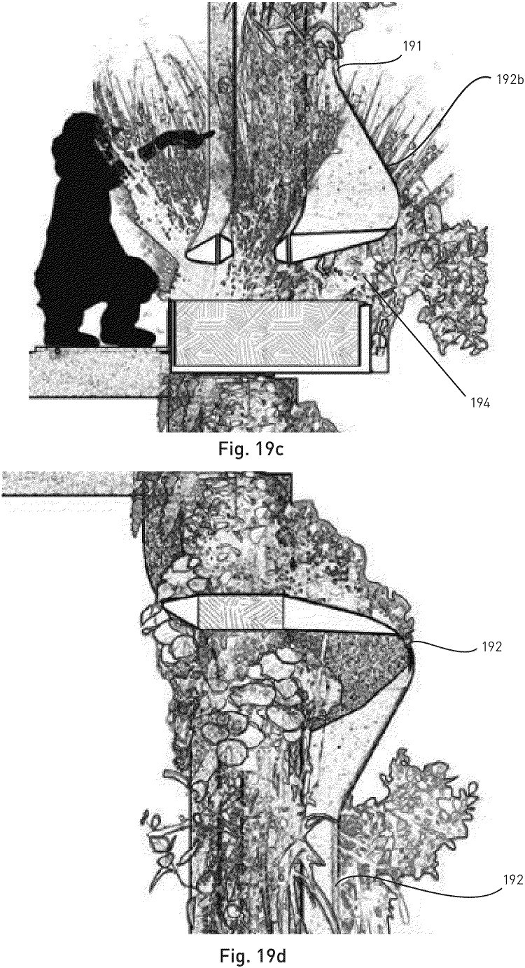

FIGS. 19a-d show a plant support structure 190 assembled from interconnecting elements 191 having a micro-awning 192. The plant support structure 190 may be constructed according to any one, or combinations, of the plant support structures disclosed herein. The interconnecting elements 191 may be constructed according to any one of the interconnecting elements disclosed herein but having at least one micro-awning 192.

As best seen in FIG. 19d, the micro-awning 192 is formed as a curvilinear surface projecting outwardly from the interconnecting elements 191. The micro-awning 192 may be formed integrally with an interconnecting element 191 or made separately and subsequently connected to the interconnecting element 191.

As best seen in FIG. 19a, the micro-awnings 192 of each interconnecting element 191 projects horizontally outwards from the plant support structure 190. Depending on how the interconnecting elements 191 are disposed within the plant support structure 190, the micro-awnings 192 may be disposed towards the top of the respective interconnecting elements 191 (see micro-awnings 192a in FIG. 19b) or towards the bottom of the respective interconnecting elements 191 (see micro-awnings 192b in FIG. 19b). It is also envisaged that each interconnecting element 191 may have a micro-awning 192 at each end of the interconnecting element 191 (e.g. at the top and bottom of the interconnecting elements 191 when disposed within the plant support structure 190). As indicated in FIG. 19a, the sun passing to the building is affected by the structure and the angle of sunlight. FIG. 19a shows an example of winter sun versus summer sun, with more of the winter sun traversing the structure than the summer sun.

When the micro-awnings 192 are disposed at the top of the interconnecting elements 191, the micro-awnings 192 may provide shading for a building (e.g. building 193 in FIGS. 19a and 19b). The shading provided by the micro-awnings 192 may reduce the amount of direct sunlight impinging on the building 193 and/or entering the building 193 (e.g. through windows). Reducing the amount of direct sunlight impinging on and/or entering the building 193 may reduce the heat load on the building 193, which may therefore reduce the overall cooling load of the building 193 required to maintain the interior of the building at a comfortable temperature. The micro-awnings 192 may also reduce the amount of direct sunlight plant growing in the plant support structure 190 are exposed to, thereby reducing the heat load that the plants are exposed to.

Further, the shading provided by the micro-awnings 192 may create a greater variety of micro-climates within the plant support structure 190. Increasing the variety of micro-climates within the plant support structure 190 may increase the biodiversity of flora and fauna the plant support structure 190 can support.

As best seen in FIG. 19c, when the micro-awnings 192 are disposed at the bottom of the interconnecting elements 191, the micro-awnings 192 form a defensive space 194 for fauna. FIG. 19c is an enlarged view of the section within the dashed box of FIG. 19b. Interconnecting elements 191 having micro-awnings 192 are both ends may provide the advantages discussed above for micro-awnings being disposed at the top and bottoms of interconnecting elements 191.

The micro-awnings 192 provide a horizontal surface on which plants growing in the plant support structure 190 may grow. The micro-awnings 192 may restrict/prevent plants growing in the plant support structure 190 from drooping down in front of the openings of blocks (e.g. blocks 11, 41b, 43b described above) below, thereby reducing obstruction of the openings of the blocks. This may result in more natural light entering the building 193 and maintaining the outlook from within the building 193 as well as allowing more light to plants that would otherwise be shaded by drooping plants, allowing for increased biodiversity of flora.

The micro-awnings 192 may also provide wind protection for plants growing in the plant support structure 190 and for fauna living in the plant support structure 190. This may increase plant growth and biodiversity within the plant support structure 190.

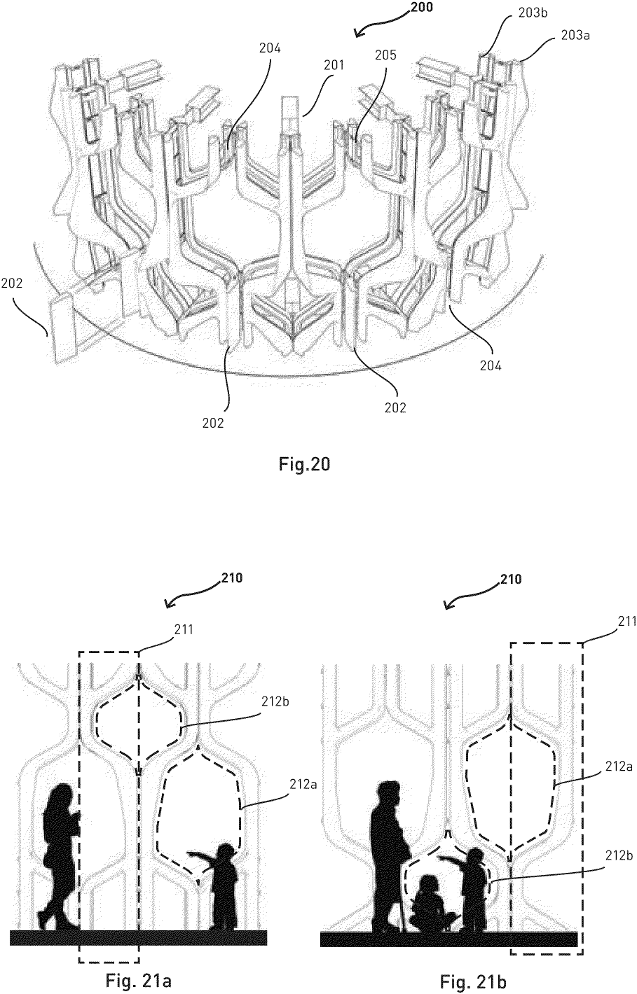

FIG. 20 shows a plant support structure 200 having a curve. The plant support structure 200 is constructed from interconnecting elements 201 and has a front layer 203a and a back layer 203b. The plant support structure 200 may be constructed according to any one, or combinations, of the plant support structures disclosed herein. The interconnecting elements 201 may include any one, or combinations, of the interconnecting elements disclosed herein.

The interconnecting elements 201 are disposed at an angle relative to adjacent interconnecting elements 201 to provide a plant support structure 200 with a curve. It is envisaged that the interconnecting elements 201 may be disposed at a variety of different angles relative to adjacent interconnecting elements 201 to create a plant support structure 200 having a variety of curves. Accordingly, it will be appreciated that the interconnecting elements 201 may be disposed at an angle relative to adjacent interconnecting elements 201 to create plant support structure 200 that at least substantially follows the face of a building and/or wraps around a corner of a building. Alternatively, the interconnecting elements 201 may be disposed at angles relative to adjacent interconnecting elements 201 to create a plant support structure 200 in the form of a free standing pavilion/wall or fence having one or more curves.

As can be seen in FIG. 20, the front layer 203a and the back layer 203b have an equal amount of interconnecting elements but the back layer 203b has a smaller radius of curvature compared to the front layer 203a. This results in gaps 204 between several of the interconnecting elements 201 in the front layer 203a. These gaps 204 may reduce the amount of plants that the plant support structure 200 may support. Accordingly, to address this issue, a wedge-shaped element 202 may be disposed in each gap 204. Each wedge-shaped element 202 at least partially fills one of the gaps 204.

Each wedge-shaped element 202 may be coupled to the same support framework 205 as each of the interconnecting elements 201 of the plant support structure 200. The support framework 205 may be formed from the support elements 12a as described above.

FIGS. 21a-b show a portion of a plant support structure 210, which is similar to plant support structures 10, 16, 40 and 50, except that the plant support structure 210 is constructed from interconnecting elements 211 having a different configuration to the interconnecting elements 10c, 10d, 41a, and 43a. The interconnecting elements 211 are assembled together to form the plant support structure 210 in a similar manner to that described above with respect to plant support structures 10, 16, 40, and 50.

In FIG. 21a the interconnecting elements 211 are disposed in such a way as to form blocks 212a and 212b, where blocks 212b are disposed above blocks 212a in the plant support structure 210. In FIG. 21b, the interconnecting elements 211 are flipped vertically so that the blocks 212a are disposed above blocks 212b in the plant support structure 210.

In FIG. 21a, the blocks 212a are suitable for adults to look through, while smaller children may not be able to see through the blocks 212a. In FIG. 21b, smaller children are able to see through the blocks 212b, while adults are able to see through blocks 212a. Accordingly, it will be appreciated that the interconnecting elements 211 may be disposed in a variety of different orientations to form plant support structures 210 having different configurations or to form different configurations within a plant support structure 210 (e.g. a plant support structure including both configurations illustrated in FIG. 21a and FIG. 21b).

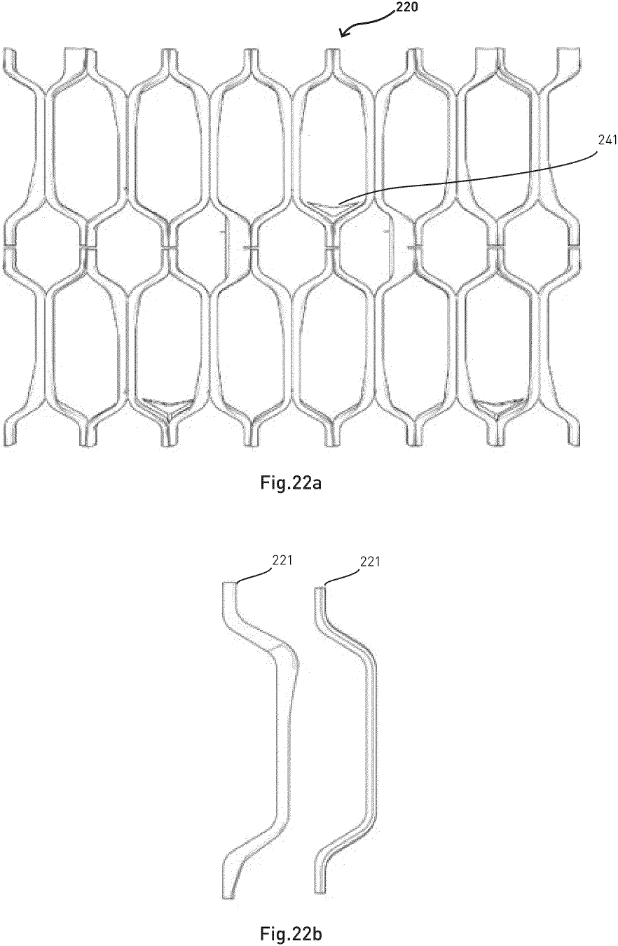

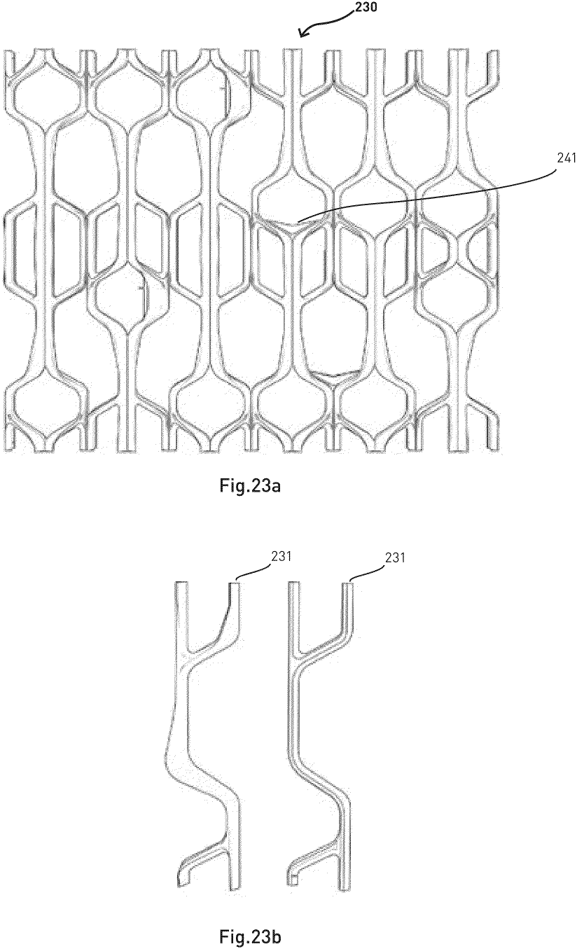

FIG. 22a shows a portion of a plant support structure 220, which is similar to plant support structures 10, 16, 40, and 50, except that plant support structure 220 is assembled from interconnecting elements 221 (see FIG. 22b) having a different configuration to the interconnecting elements 10c, 10d, 41b, and 43b. FIG. 22b shows front and rear views of the interconnecting elements 221 (right and left figures, respectively). The interconnecting elements 221 are assembled together to form the plant support structure 220 in a similar manner to that described above with respect to the plant support structures 10, 16, 40 and 50.

FIG. 23a shows a portion of a plant support structure 230, which is similar to plant support structures 10, 16, 40, and 50, except that plant support structure 230 is assembled from interconnecting elements 231 (see FIG. 23b) having a different configuration to the interconnecting elements 10c, 10d, 41b, and 43b. FIG. 23b shows front and rear views of the interconnecting elements 221 (right and left figures, respectively). The interconnecting elements 231 are assembled together to form the plant support structure 230 in a similar manner to that described above with respect to the plant support structures 10, 16, 40 and 50.

It is envisaged that plant support structures may be formed using a combinations of the interconnecting elements disclosed herein. Accordingly, plant support structures may be formed using one or more of the interconnecting elements disclosed herein to create different patterns and variations within the plant support structure in order to mimic nature (e.g. to mimic fallen tree branches and/or logs or to mimic the complex canopy structure of bushes or trees with a variety of voids of various sizes). This may increase the biodiversity of the flora and fauna that the plant support structure may support.

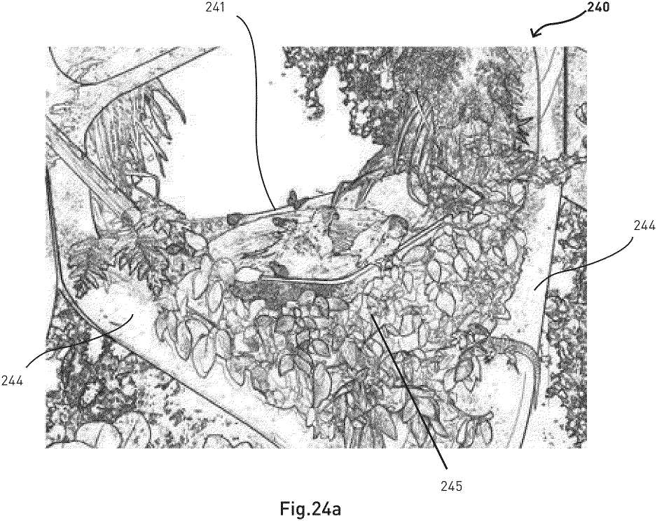

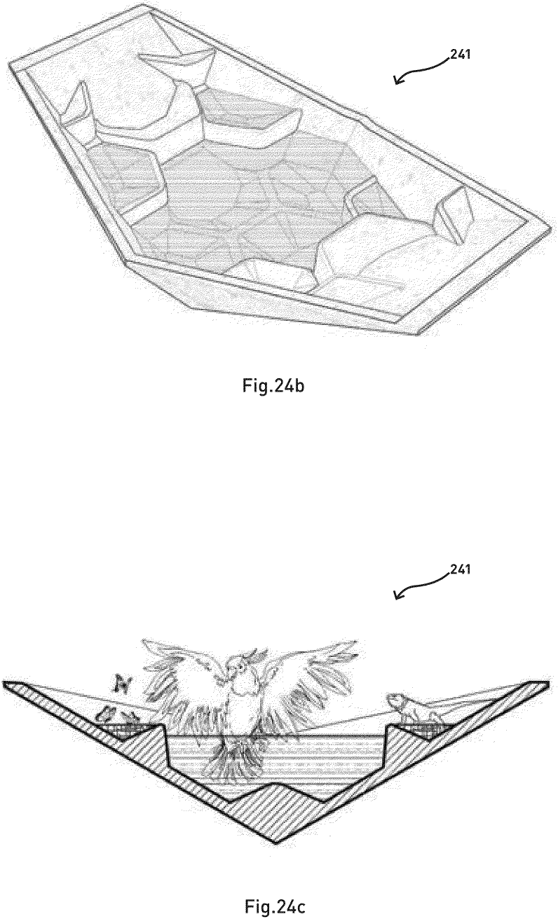

FIG. 24a shows a portion of a plant support structure 240 having a basin 241 in the form of a bird bath. The plant support structure 240 may be constructed according to any one, or combinations, of the plant support structures disclosed herein. The basin 241 is disposed in a block 242 (e.g. blocks 11, 43a and 43b) defined by the plant support structure 240. The basin 241 may be connected to the plant support structure 240 using any suitable method known in the art. Alternatively, the basin 241 may be formed integrally with an interconnecting element.

Referring to FIGS. 24b-c, the basin 241 has a gentle slope that mimics the edge of a natural body of water. The basin 241 defines different depths (see FIG. 24c) that are suitable for fauna of different sizes. Accordingly, a variety of differently sized fauna are able to use the basing 241. Further, the basin 241 and interconnecting elements 244 forming the plant support structure 240 (see FIG. 24a) define a defensive space 245 for fauna.

Referring to FIGS. 22a and 23a, the plant support structures 220 and 230 include a basin 241. As can be seen in these figures, the basin 241 is shaped to fit within a vertex of a block 222 and 232 defined by the plant support structures 220 and 230, respectively.

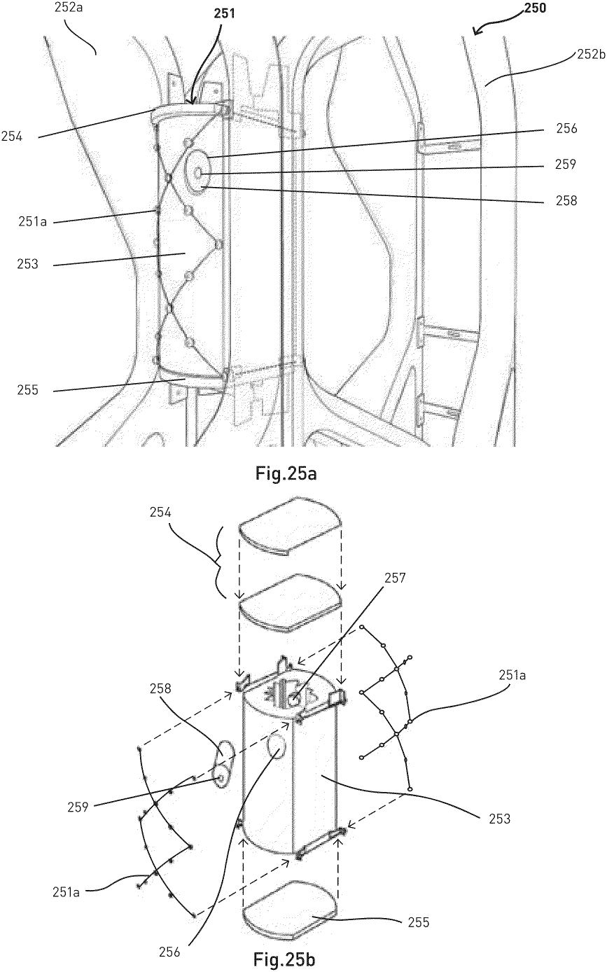

FIG. 25a shows a portion of a plant support structure 250 having a nesting box 251 disposed between the front layer 252a and the back layer 252b of the plant support structure 250. The plant support structure 250 may be constructed according to any one, or combinations, of plant support structures disclosed herein. The prototype of the plant support structure shown in FIG. 11b includes a nesting box 251.

The nesting box 251 is supported by a wire cage 251a connected to the plant support structure 250. However, it is envisaged that the nesting box 251 may be connected to the plant support structure 250 using any other suitable means known in the art. It is also envisaged that the nesting box 251 need not be connected between the front layer 252a and the back layer 252b, but may be connected to only one of the layers 252a or 252b.

The nesting box 251 has a body 253, a top cap 254, a bottom cap 255, and a hole 256. The body 252 defines an interior volume 257 (see FIG. 25b). The hole 256 allows fauna (e.g. birds) to enter the interior volume 257 of the body 253 to make a nest in the interior volume 257.

The body 253 may be made from a hollow log from logging waste and cut to a desired size. The top and bottom caps 254 and 255 are connected to either end of the body 253 to define the interior volume 257.

A plug 258 with a hole 259 is inserted into the hole 256 of the body 253. The hole 259 of the plug 258 entices birds. The birds may then start removing small parts of the plug 258 so that they can enter the interior volume 257 of the body 253. The plug may be made of a termite mixture or any other suitable material which is safe for fauna and can removed by fauna.

Although the body 253 has been described as being constructed using logging waste, it is also envisaged that the body 253 may be made artificially and made to resemble wood.

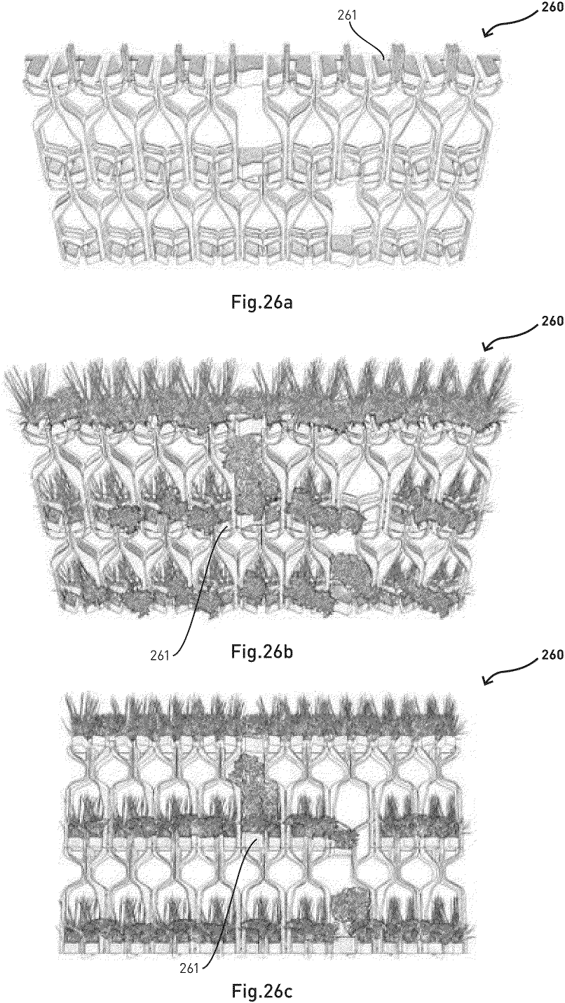

FIGS. 26a-c show a plant support structure 260 having a plurality of planter boxes 261 (only one labeled for clarity of illustration). The planter boxes 261 may be connected to the plant support structure 260 and/or building disposed behind the plant support structure 260 using any suitable methods known in the art. The plant support structure 260 may be assembled according to any one, or combinations, of the plant support structures disclosed herein.

Different plant types/species require different soil types and moisture levels. For example, vertical garden systems, such as the plant support structures disclosed herein, are typically suited for rainforest plants and, therefore, may not be well suited for other plant types/species.

The planter boxes 261 can be filled with different media at different depths to suit a wide variety of different plant types/species. Accordingly, the planter boxes 261 may increase the variety of plant types that are able to grow in the plant support structure 260. Increasing the variety of flora that the plant support structure 260 can support may also increase the biodiversity of fauna living in the plant support structure 260.

The planter boxes 261 can also be disposed at different locations within the plant support structure 260 to vary the lighting conditions the planter boxes 261 are exposed to. Accordingly, the location of the planter boxes 261 may be chosen such that the lighting conditions that planter boxes 261 are exposed to suit the plant growing in the planter boxes 261.

The planter boxes 261 may also be sized to allow larger plants (e.g. trees and/or shrubs) to grow within the plant support structures 260.

The planter boxes 261 may be irrigated by a different irrigation system to the irrigation system used to water the plants growing in the channels (e.g. channels 11,19, 44, 73 described above). Alternatively, the planter boxes may be irrigated by the same irrigation system used to water the plants growing in the channels of the plant support structure 260.

The planter boxes 261 may be constructed from a porous material such that water can pass through the wall of the planter boxes 261. Water passing through the wall of the planter boxes 261 may fall on to plants growing in planter boxes 261 below and/or plants growing in the channels of the plant support structure 260, thereby improving the water usage within the plant support structure 260.

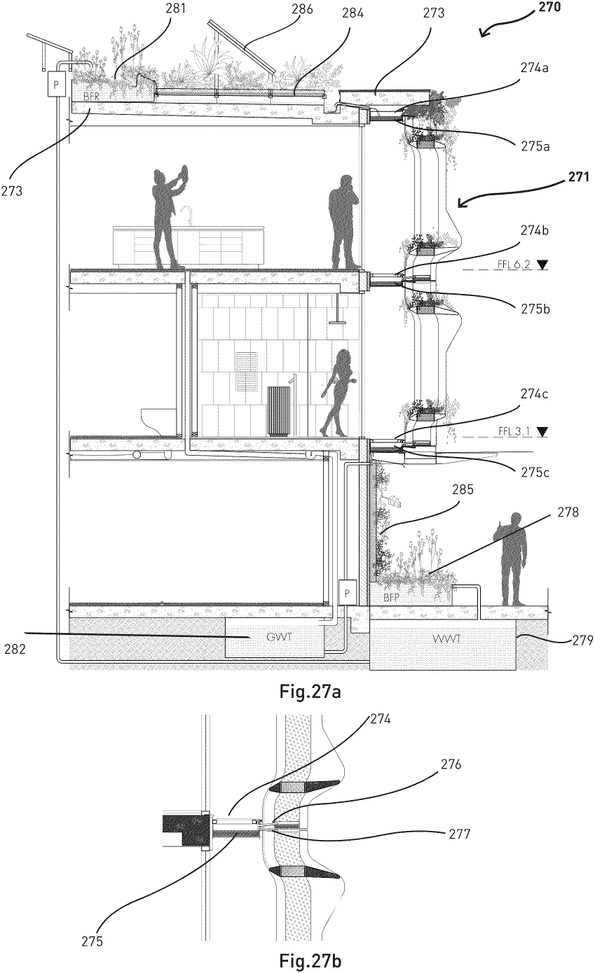

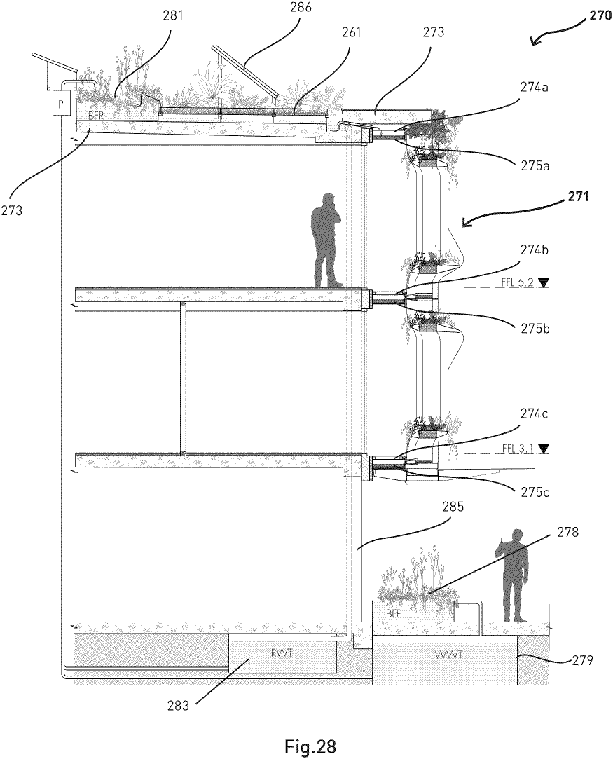

FIGS. 27a and 28 show a plant support system 270 having a plant support structure 271. The plant support structure 271 may be assembled according to any one, or combination, of the plant support structures disclosed herein. The plant support system 270 is constructed to mimic the hydrological system of Heathland scrub and hanging swamp systems.

Heathland scrub slows down and stores water from rainfall events and this water is filtered into the hanging swamp system suspended off a cliff. In FIG. 27a, growing on the roof 272 of the building 273 are plants 284 that mimic the Heathland scrub and the plant support structure 271 mimics the hanging swamp system suspended off a cliff.

The plant support structure 271 has platforms 274 (e.g. platforms 12b described above). Underneath each platform 274 is a reservoir 275 configured to collect water from and supply water to the plant support structure 271.

Referring to FIG. 27b, each reservoir 275 has an inlet channel 276 configured to direct excess water from the plant support structure 271 into the reservoir 275. Each reservoir 275 has a fluid outlet 277 configured to direct water from the reservoir 275 to the plant support structure 271. In particular, the fluid outlet 277 of each reservoir 275 may provide water to plants growing in the plant support structure 271 that are disposed below the reservoir 275. The fluid outlet 277 may be a wicking material that is in fluid communication with the fluid reservoir 275 and the plant support structure 271. The excess water in the plant support structure 271 may be from the irrigation system of the plant support system 270 and/or rainfall.

Excess water flowing through the plant support structure 271 may also be collected in in a pond 278 disposed at the bottom of the plant support structure 271. Excess water in the pond 278 may then be redirected to a waste water tank 279. Water in the waste water tank 279 can then be pumped to a biofiltration reservoir 281 disposed on the roof 272 of the building 273. The biofiltration reservoir 281 has plants growing in it that are configured to filter the water in the biofiltration reservoir 281. Water in the biofiltration reservoir 281 is then used to water the plants 284 growing on the roof 272 of the building 273. Excess water from the plants 284 is directed to the top most reservoir 275a, where the water may subsequently enter the plant support structure 271 as described above.

The plant support system 270 also includes a grey water tank 282, which is configured to collect grey water from the building 273. Water in the grey water tank 282 is pumped to a green wall system 285, where it is filtered by plants growing in the green wall system 285 before entering the biofiltration reservoir 281. Water in the biofiltration reservoir 281 is used to water the plants 284 and the plants in the plant support structure 271 as described above.

The plant support system 270 also includes a rainwater tank 283, which is not shown in FIG. 27a. FIG. 28 shows the plant support system 270 omitting the grey water tank 283 but showing the rainwater tank 283. The rainwater tank 283 and the grey water tank 281 are isolated from each other.

The rainwater tank 283 is configured to collect rainwater from the building 273 (e.g. via gutters of the building 273). Water in the rainwater tank 283 is pumped into the biofiltration reservoir 281, where it is filtered by the plants growing in the biofiltration reservoir 281 before being used to water the plants growing in the planter boxes 261 and in the plant support structure 271.

The plant support system 270 also includes photovoltaic (PV) panels 286 that can supply electrical power to one or more electrical components of the plant support system 270. For example, the PV panels 286 may provide electrical power to pumps (not shown) of the plant support system 270 to move water from the waste water tank 279 and the rainwater tank 283 to the biofiltration reservoir 281. The PV panels 286 may be positioned to provide shading to plants, at least during certain times of the day. The shading may assist to protect the plants from damaging heat events. The PV panels 286 may also be positioned to create actual or perceived defensive spaces, providing habitat corridors to extend beneath them, over a roof area.

FIGS. 29a-d show planting arrangements 290a-d. The planting arrangements 290a-d may form the porous material disposed in the channels of the plant support structure disclosed herein and/or may be used in addition to other porous materials disposed in the channels of the plant support structures disclosed herein. Each planting arrangement 290a-d has a wire 291 and a porous bag 292 formed from a porous lightweight substrate. The wire 291 supports the porous bag 292.The porous bags 292 are filled with a suitable medium depending on the types/species of plants to be grown in the planting arrangements 290a-d. Plants may then be planted through the porous lightweight substrate forming the porous bags 292.

In FIG. 29a, the wire 291 of the planting arrangement 290a is connected between two structural members (not shown). The structural members may be the front and back layers of a plant support structure or interconnecting elements of a plant support structure. The porous bags 292 are then disposed on, and secured to, the wire 291. The porous bags 292 may be secured to the wire 291 using any suitable methods known in the art.

In FIG. 29b, the planting arrangement 290b has two wires coupled between two interconnecting elements 293 of a plant support structure according to any of the embodiments disclosed herein. The interconnecting elements 293 may be any one of the interconnecting elements disclosed herein. The porous bag 292 is disposed between and supported by the wires 291 such that the porous bag 292 is disposed between the interconnecting elements 293. The wires 291 therefore form a cage which supports the porous bag 292. In this example, the porous bag 292 is supported horizontally by the wires 291. However, it will be appreciated that the wires 291 can be coupled between interconnecting elements 293 to form a cage that supports the porous bag 291 at any angle.

The planting arrangement 290c is similar to planting arrangement 290b, except that the wires 291 of the planting arrangement 290c are coupled between interconnecting elements (not shown) to form a cage that supports the porous bag 292 vertically.

In FIG. 29d, the wire 291 of the planting arrangement 290d is coupled between and follows the shape of the interconnecting elements 293 of a plant support structure according to any of the embodiments disclosed herein. The interconnecting elements 293 may be any one of the interconnecting elements disclosed herein. The porous bag 292 is then disposed on the wire 291 between the interconnecting elements 293. The porous bags 292 may then be secured to the wire 291 using any suitable methods known in the art. In this example, the wire 291 is coupled to the interconnecting elements 293 such that the porous bag 292 substantially follows the shape of the interconnecting elements 293.

FIG. 29e shows a latticework 290e. The latticework 290e may form the porous material disposed in the channels of the plant support structure disclosed herein and/or may be used in addition to other porous materials disposed in the channels of the plant support structures disclosed herein.

The latticework 290e is formed of a complex latticework rigid structure that is able to grow plant life. The geometry of the latticework 290e is designed to both protect plant roots and transfer water. The outer layer of the latticework 290e may be created from a nonflammable material that has a complex surface texture to capture and hold organic matter for plant nutrients and moisture. The latticework 290e may be 3d printed, cast, and dipped or formed by lump pumice. The latticework 290e may be retained in the channels of the plant support structures using any suitable method known in the art. For example, the latticework 290e may be retained in the channels using netting, cages, or similar connected to the plant support structure.

The planting arrangements 290a-d and/or latticework 290e may be disposed in any of the plant support structures disclosed herein at a variety of locations within the plant support structure. The planting arrangements 290a-d and/or latticework 290e may be disposed adjacent to other planting arrangements 290a-d and/or latticework 290e so that they follow an outer surface of the plant support structure (see FIG. 29a). The planting arrangements 290a-d and/or latticework 290e may be disposed between interconnecting elements of a plant support structure (see FIG. 29b). The planting arrangements 290a-d and/or latticework 290e may be hung vertically from one or more interconnecting elements for a plant support structure (See FIG. 29c). The planting arrangements 290a-d and/or latticework 290e may be disposed on one or more interconnecting elements of a plant support structure (see FIG. 29d).

FIG. 29f shows a planting arrangement 290f that allows climbing plants to grow within any one, or combinations, of the plant support structures disclosed herein. The planting arrangement 290f has a plant support member 294 that is connected between interconnecting elements 293 of a plant support structure and on which climbing plants may be hung. Alternatively, the plant support member may be connected to a single interconnecting 293 element in a cantilever manner.

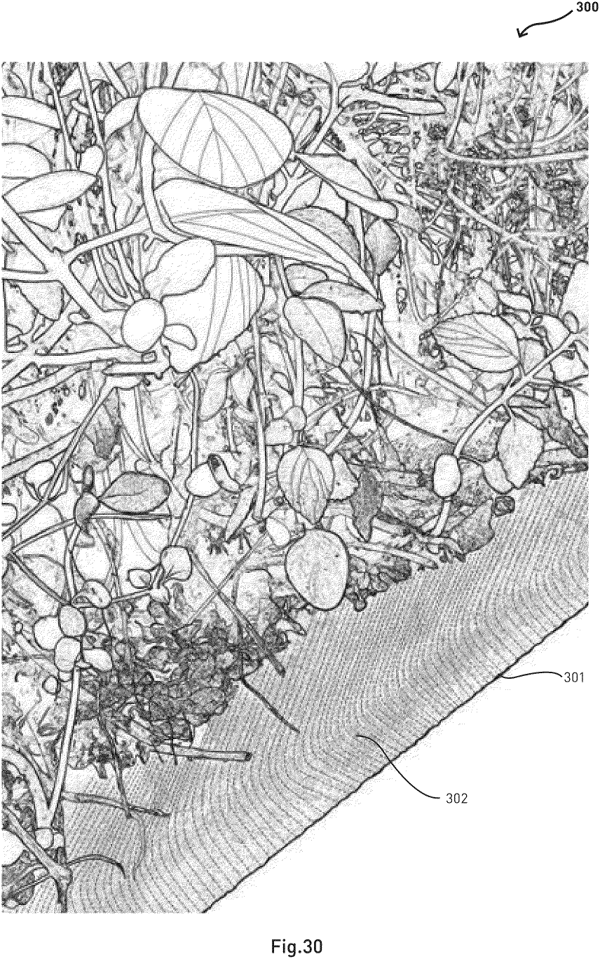

FIG. 30 shows a portion of a plant support structure 300 having an interconnecting element 301 having a textured surface 302. The plant support structure 300 may be constructed according to any one, or combinations, of the plant support structures disclosed herein. The interconnecting element 301 may be constructed according to any one of the interconnecting elements disclosed herein.

The textured surface 302 of the interconnecting element 301 may capture leaf litter and debris from plants growing in the plant support structure 300, which may aid in the formation of soil and, therefore, allowing for growth of plants on the textured surface 302 of the interconnecting element 301.

The textured surface 302 of the interconnecting element 301 may also aid with retaining water on the interconnecting element 301, thereby improving water flow and retention over the interconnecting elements 301 of the plant support structure 300.

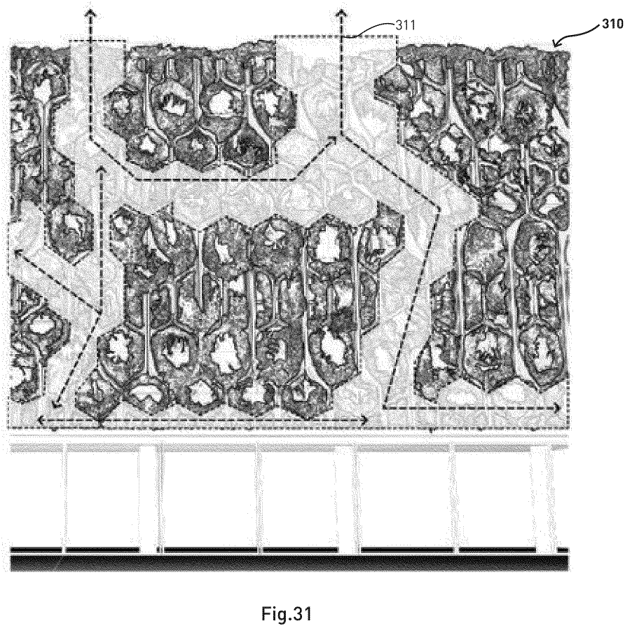

FIG. 31 shows a plant support structure 310, which may be formed according to any one, or combinations, of the plant support structures disclosed herein.

The plant support structure 310 defines a network of continuous corridors 311 (generally indicated by the dashed arrows in FIG. 31) that provide continuous corridors for fauna between the top and bottom of the plant support structure 310. Accordingly, fauna living within the plant support structure 300 can move between the top and bottom of the plant support structure 300 via the continuous corridors 311, without being fully exposed. This may provide safe spaces for fauna within the plant support structure 310, which may increase biodiversity of fauna living in the plant support structure 310.

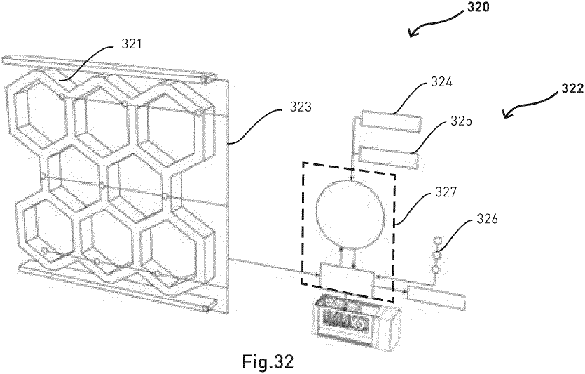

FIG. 32 shows a schematic of a control system 320 having a plant support structure 321 and a control system 322. The plant support structure 321 may be assembled according to any one, or combination, of plant support structures disclosed herein.

The control system 322 includes an array of sensors 323 disposed within the plant support structure 321, an external data module 324, a user input module 325, localized sensors 326, and a processing unit 327.

The array of sensors 323 may be configured to obtain data from a plurality of locations within the plant support structure 321. This data may include water levels within reservoirs 275, water flow rates through the plant support structure 321, and moisture levels of soils at a plurality of locations within the plant support structure 321.

The external data module 324 is configured to gather weather data for the location of the plant support system 320. The user input module 325 allows a user to input data relating to the plant support system 320 and one or more operating parameters for the plant support system 320. The localized sensors 326 are configured to gather localized data for the plant support system 320 (e.g. light levels, humidity, air pressure).

The processing unit 327 uses the data obtained from the array of sensors 323, the external data module 324, the user module 325, and the localized sensors 326 to determine one or more operations to be performed at each of the plurality of locations within the plant support structure. The processing unit 327 may subsequently operate one or more pumps at each of the plurality of locations within the plant support structures to water the plants at those locations. The processing unity 327 may utilize cloud computing, local computing, on-board processing, and combinations thereof to determine the operations to be performed at each of the locations within the plant support structure 321. Accordingly, the processing unit 327 can monitor a plurality of location within the plant support structure 321 and control one or more components of the plant support system 320 to maintain each location within the plant support structure 321 within desired ranges (e.g. temperature, soil moisture levels, water flow rate).

The control system 322 may be able to identify potentially fatal conditions and perform one or more pre-emptive operations. For example, the control system 322 may perform water loading operations, cause more water to be stored in reservoirs (e.g. reservoirs 275 described above) of the plant support system 320. The control system 322 gathers data from the arrays of sensors 323, the external data module 324, and the localized sensors 326 and adjusts one or more operations of the plant support system 320 to preserve plant life and/or improve safety of a building associated with plant support system 320.

In the case of an anticipated fire, the control system 322 may respond to local incidents. For example, if a spike in heat is detected in a particular location of the plant support structure 321, the control system 322 may cause the irrigation system of the plant support system 320 to douse that location to mitigate a localized incident such as fire affecting the plant support structure 271 and/or a building associated with the plant support system 320.

Accordingly, the control system 322 can anticipate damaging conditions and mitigate them through water management. For example, the control system 322 may mitigate heat damage, extremes in climatic conditions, and/or fire in order to preserve plant life within the plant support structure 321 and/or improve the safety of a building associated with the plant support structure 321. In the example of a fire, the control system 322 can douse the plant support structure 321, thereby creating a saturated façade covering and protecting a building located behind the plant support structure 321.

The array of sensor 323 can also include sensors that monitor the health of plants growing in the plant support structure 321. Such sensors may monitor for the rapid increase in detrimental microorganisms growing in the plant support structure 321.

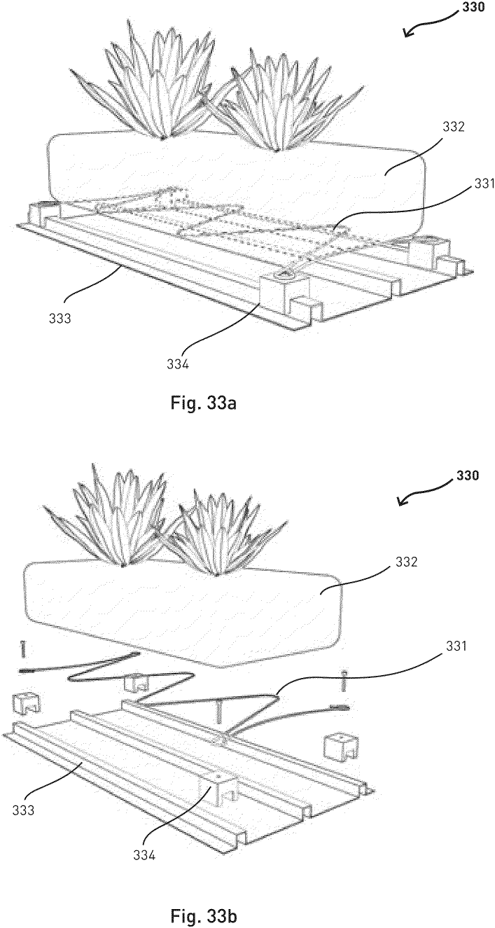

FIGS. 33a-b show a planting arrangement 330 that may be used to grow plants on a roof of a building (e.g. the plants 284 on the roof 272 of building 273 in FIGS. 27a and 28).

Similar to the planting arrangements 290a-d, planting arrangement 330 has a wire 331 and a porous bag 332 formed from a porous lightweight substrate. The wire 331 supports the porous bag 332. The porous bag 332 are filled with a suitable medium depending on the types/species of plants to be grown in the planting arrangements 330. Plants may then be planted through the porous lightweight substrate forming the porous bags 332.

The wire 331 is coupled to a roof 333 of a building (not shown) vis support brackets 334 such that the wire is suspended at a distance above the roof 333. The porous bag 332 is then disposed on the wire 332 such that the porous bag is suspended at a distance above the roof 333.

FIG. 34 shows a plant support structure 340 in the form of a free standing pavilion or wall/fence. The plant support structure 340 may be formed according to any one, or combination, of plant support structures disclosed herein. One or more of the interconnecting elements 341 forming the plant support structure 340 are coupled to foundation blocks 343. The interconnecting elements 341 may be any one of the interconnecting elements disclosed herein.

Each foundation block 343 has one or more water tanks 342 that are configured to collect and store excess water from the plant support structure 340. The excess water may be from watering plants growing in the plant support structure 340 and/or rainwater if the plant support structure is installed outside. The foundation blocks 342 may be formed from concrete, or may be tanks filled with water as ballast to allow for ease of installation.

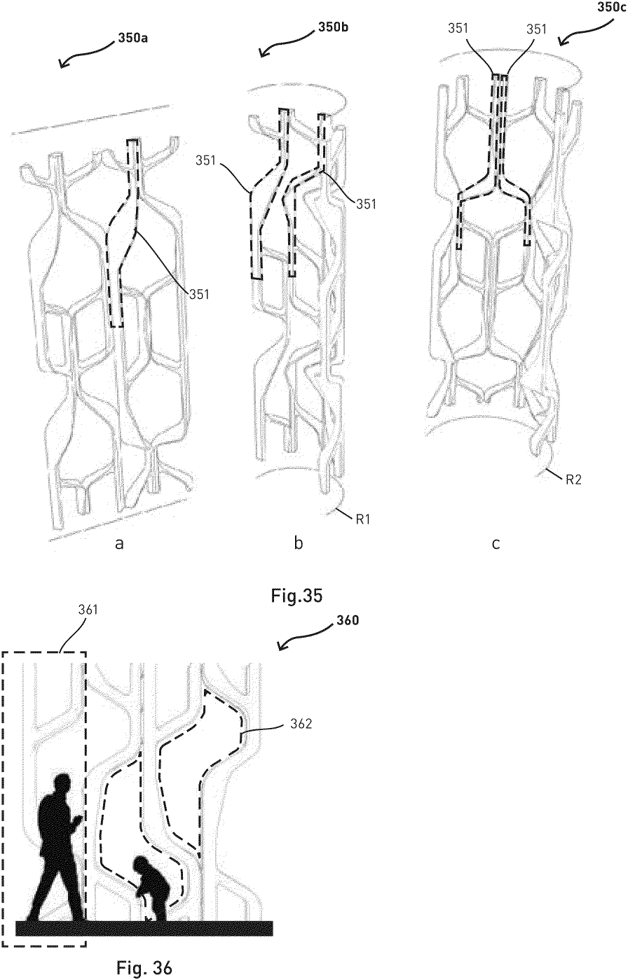

FIG. 35a-c illustrate how plant support structures having different shapes may be constructed using the same interconnecting elements. Figs. 351-s only illustrate a portion of a plant support structure, which may be assembled according to any one, or combination, of plant support structures disclosed herein.

In FIG. 35a, the interconnecting elements 351 are disposed adjacent to each other to form a linear plant support structure 350a. In FIG. 35b, the interconnecting elements 351 are disposed at an angle to each other to form a plant support structure 350b having a radius of curvature of R1. In FIG. 35c, the interconnecting elements 351 are disposed at an angle to each other to form a plant support structure 350c having a radius of curvature of R2. Accordingly, it will be appreciated that plant support structures having different shapes can be formed from the interconnecting elements.

FIG. 36 shows a portion of a plant support structure 360, which is similar to plant support structures 10, 16, 40 and 50, except that the plant support structure 360 is constructed from interconnecting elements 361 having a different configuration to the other interconnecting elements disclosed herein. The interconnecting elements 361 are assembled together to form the plant support structure 360 in a similar manner to that described above with respect to plant support structures 10, 16, 40, and 50.

Unlike the blocks 11, 41b, and 43b of the plant support structures 10, 16, and 40, the interconnecting elements 361 form blocks 362 having irregular shapes. Accordingly, it will be appreciated that the interconnecting elements used to form plant support structures may have a variety of shapes may form a variety of blocks within the plant support structures.

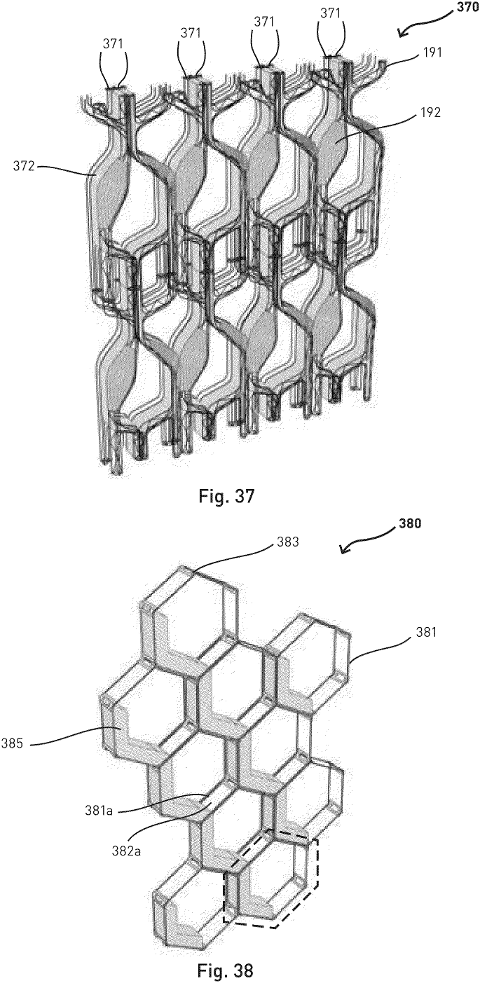

FIG. 37 shows a portion of a plant support structure 370 formed from interconnecting elements 191 and having a plurality of channels 371.

Disposed in the channels 371 is porous material 372. The porous material 372 may include any one, or combination, of the planting arrangements 290a-d and latticework 290e. As can be seen in FIG. 37, the porous material 372 extends from the top to the bottom of the channels 371 of the plant support structure 370. Micro-awnings 192 are connected to the 3 dimensional truss 391 of the plant support structure. Micro-awnings 192 may be constructed from sheet metal, perforated sheet metal, cast material, or fabric.

FIG. 38 shows a portion of a plant support structure 380 formed from interconnecting elements 381. Each interconnecting element 381 may be in the form of a rectangular frame having an opening 382, but may be in other forms including irregular geometries as an irregular trapezium.

The interconnecting elements 382 are interconnected using brackets 383 to form a vertically extending arrangements having an interlaced hexagonal geometry. The interlaced hexagonal geometry includes a plurality of geometric blocks 384. The interconnecting elements 382 may be interconnected to form geometric blocks having other shapes.

Porous material 385 is disposed on, and through several, interconnecting elements 381 to form a plurality of continuous lengths of porous material 385 throughout the plant support structure 380. The porous material extends through the openings 382 of several of the interconnecting elements (e.g. openings 382a of interconnecting element 381a).

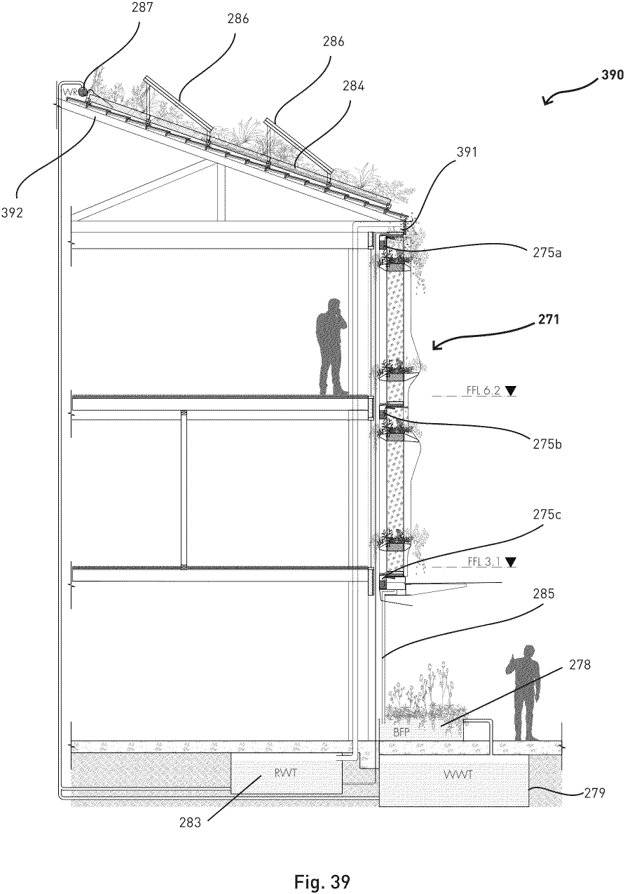

FIG. 39 shows a plant support system 390 similar to the plant support system 270 described above, except that the plant support system 390 does not include the biofiltration reservoir 281 of the plant support system 270 and the plants 284 of the plant support system 390 are installed on an angled roof 392. The roof may be any suitable construction.

Features of the plant support system 390 that are identical or equivalent to those of the plant support system 270 are provided with the same reference numerals. For features that are identical between the plant support system 270 and the plant support system 390, it will be appreciated that the above description of these features in relation to the plant support system 270 is also applicable to the corresponding identical/equivalent features found in the plant support system 390. Accordingly, the identical features between the plant support system 270 and the plant support system 390 will not again be described below in relation to the plant support system 390 as these features of the plant support system 390 have already been described above with respect to the plant support system 270.

Further, the plant support structure 271 of the plant support structure 271 of the plant support system 390 is installed closer to the building 391 compared to the plant support structure 271 in the plant support system 270. Accordingly, the plant support system 390 does not include the platforms 274 of the plant support system 270. The reservoirs 275 of the plant support system 390 are located in the space between the external face of the building 391 and the internal face of the plant support structure 271.

Instead of the biofiltration reservoir 281 of the plant support system 270, the plant support system 390 has an irrigation outlet 287 configured to dispense water to the plants 284 growing on the angled roof 392 at, or close to, the highest point of the angled roof 392. The water then flows down from the angled roof 392, watering the plants 284 along the way. Excess water from the plants 284 is directed to the topmost reservoir 275a, wherein the water may subsequently enter the plant support structure 271 as described above with respect to the plant support system 270.

The plant support system 390 operates in a similar manner to the plant support system 270, except that water in the waste water tank 279 and rainwater tank 283 are pumped to the irrigation outlet 286 when watering of the plants 284 is required.

It will be appreciated that the PV panels 285 may provide electrical power to pumps (not shown) of the plant support system 390 to pump water from the waste water tank 271 and rainwater tank 283 to the irrigation outlet 286. The PV panels 285 may also provide shading for plants 284 growing on the roof to shape plants 284 during extreme weather events. The shading provided by the PV panels 285 may also increase the biodiversity of plants 284 growing on the roof 392.

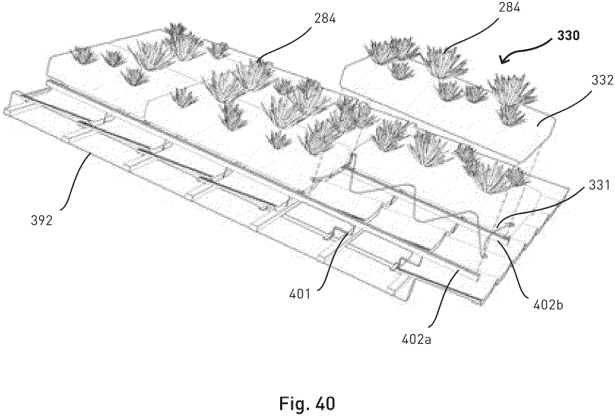

FIG. 40 illustrates how the plants 284 of the plant support system 390 may be installed on the angled roof 392 of the building 391. The plants 284 may be installed on the angled roof 392 of the building 391 using the planting arrangements 330 and roof tile solar panel mounts 401.

The roof tile solar panel mounts 401 may be installed on the angled roof 392 according to any suitable methods known in the art. Each roof tile solar panel mount 401 includes a pair of rails 402a and 402b. The wire 331 of each planting arrangement 330 is coupled between the rails 402a and 402b of one of the roof tile solar panel mounts 401 such that the wire 331 is suspended above, and substantially parallel to, the angled roof 392. The porous bag 332 of each planting arrangement 330 is then disposed on its respective wire 331 such that the porous bag 332 is suspended above, and substantially parallel, to the angled roof 392. The porous bag 332 may be secured to its respective wire 331 using any suitable methods known in the art.

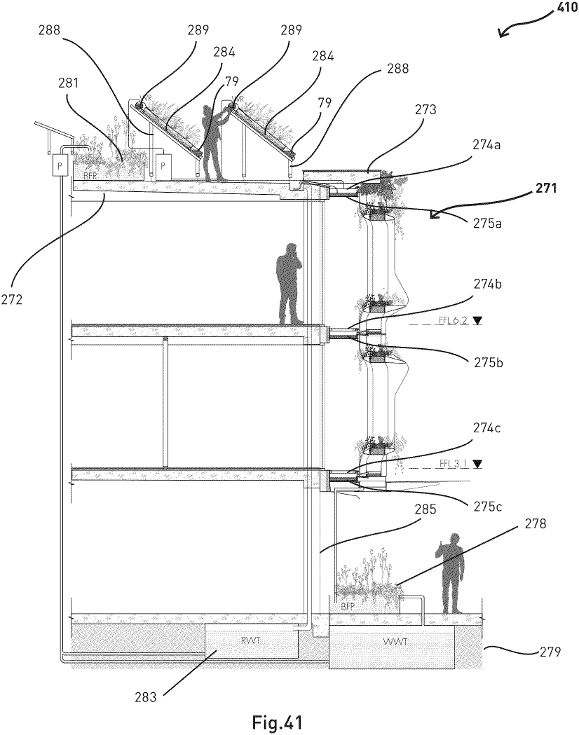

FIG. 41 shows a plant support system 410 that is similar to the plant support system 270, except that the plants 284 of the plant support system 410 are installed on an angled frame 288 disposed on the roof 272 of the building 273.

Features of the plant support system 410 that are identical or equivalent to those of the plant support system 270 are provided with the same reference numerals. For features that are identical between the plant support system 270 and the plant support system 410, it will be appreciated that the above description of these features in relation to the plant support system 270 is also applicable to the corresponding identical/equivalent features found in the plant support system 410. Accordingly, the identical features between the plant support system 270 and the plant support system 410 will not again be described below in relation to the plant support system 410 as these features of the plant support system 410 have already been described above with respect to the plant support system 270.

The plant support system 410 operates in a similar manner to the plant support system 270, expect that water in the biofiltration reservoir 281 is pumped out of the biofiltration reservoir 281 and dispensed from irrigation outlets 289 disposed at the top of each angled frame 288. The dispensed water flows down each angled frame 288 watering the plants 284 along the way. Excess water from each angled frame 288 is directed to a water collector 79 located at the bottom of the porous material. The water may then be pumped back to irrigation outlets 289, to form a closed irrigation system. Additional excess water from overflow or lost through dripping is directed over the roof surface to the topmost reservoir 275a, wherein the water may subsequently enter the plant support structure 271, as described above with respect to the plant support system 270. Water to irrigate plant support structure 271 is also pumped to topmost reservoir 275a from the biofiltration reservoir 281.

The angled frames 288 may be frames used to mount PV panels and the plant 284 may be installed on the angled frames 288 using the planting arrangements 330, with the wire 331 of each planting arrangement 330 coupled one angled frame 288 or between two angled frames 288.

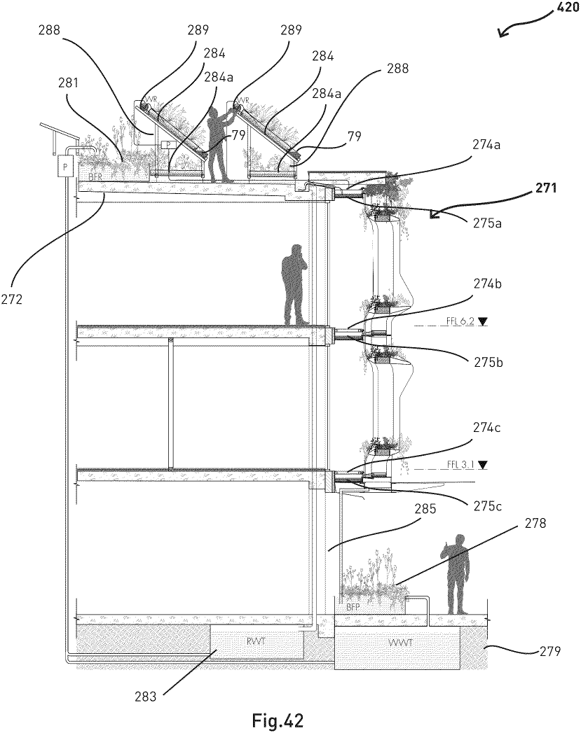

FIG. 42 shows a plant support structure 420 that is similar to the plant support system 410, except that the plant support system 420 includes 420 has plants 284 disposed underneath each of the angled frames 288.

The plant support system 410 operates in a similar manner to the plant support system 410, except that water from the biofiltration reservoir 281 may also be pumped out of the biofiltration reservoir 281 to water plants 284a. Excess water from the plants 284a is directed to the topmost reservoir 275a, wherein the water may subsequently enter the plant support structure 271 as described above with respect to the plant support system 270.

The plants 284 on the angled frames 288 provide shading for the plants 284a disposed underneath the angled frames 288. The shading provided underneath the angled frames 288 may produce conditions that are suitable for shade plants, under story plants, and/or rain forest plants. Accordingly, the plants 284a may be shade plants, under story plants, and/or rain forest plants. The plants 284 may include sun loving, drought tolerant plants given they are exposed to direct sunlight.

The plants 284 on the angled frames 288 may mimic a canopy for the plants 284 disposed below the angled frames 288. Accordingly, this arrangement of plants 284 on the angled frames 288 and plants 284a disposed below the angled frames 288 may increase the biodiversity of flora that the plant support system 420 may support.

Interconnecting elements and basin disclosed herein may be formed of lightweight cast concrete, carbon capture concrete, carbon capture cementitious materials, or other impermeable or substantially impermeable material. In some embodiments, the interconnecting elements and basin disclosed herein are made of a carbon fibre reinforced concrete.

The carbon fibre reinforced concrete is concrete containing fibrous material. It contains short discrete fibres that are usually uniformly distributed and randomly oriented within the concrete. A carbon fibre reinforced concrete element is capable of carrying tension at strains greater than those at which cracking would initiate in a normal un-reinforced concrete element. Forming the interconnecting element and basin from carbon capture concrete and carbon capture cementitious materials may reduce the carbon footprint of the interconnecting element and basin.

Further, the interconnecting elements and basin disclosed herein in may be 3d printed. 3D printing the interconnecting elements may allow for the formation of interconnecting elements having complex shapes and/or surface geometries.

In another example, while in the embodiments shown, each block has a hexagonal geometry, alternative embodiments may have blocks of other geometries. Other example block shapes include blocks that are triangular shaped, pentagon shaped, diamond shaped, octagonal shaped, circular shaped, oval shaped and so on. In each instance, the blocks are configured to form channels for carrying water to plants accommodated in the structure. In each instance, material may be removed outside of a continuous load bearing line of increased cross sectional area, in a similar manner to that described herein in relation to the hexagonal blocks.

As used herein the terms “include” and “comprise” (and variations of those terms, such as “including”, “includes”, “comprising”, “comprises”, “comprised” and the like) are intended to be inclusive and are not intended to exclude further features, components, integers or steps.

It will be understood that the embodiments disclosed and defined in this specification extends to all alternative combinations of two or more of the individual features mentioned or evident from the text or drawings. All of these different combinations constitute various alternative aspects of the embodiments.

It will be understood that the invention disclosed and defined in this specification extends to all alternative combinations of two or more of the individual features mentioned or evident from the text or drawings. All of these different combinations constitute various alternative aspects of the invention.

1. A plant support structure for accommodating plants, the plant support structure including:
a framework including a plurality of primary elements interconnected to each other in a vertically extending arrangement, the interconnected primary elements forming a plurality of geometric blocks and vertically extending channels formed at a periphery of the geometric blocks;
wherein the channels are configured to receive therein a porous material for carrying water from a top end of the plant support structure down the channels for irrigating plants in the channels.

2. The plant support structure of claim 1, wherein at least one of the primary elements has a micro-awning for proving shading to plants within the channels and/or to a building associated with the plant support structure.

3. The plant support structure of claim 1, wherein the interconnected primary elements in the framework form an interlaced hexagonal geometry.

4. The plant support structure of claim 1, wherein the framework has a first layer and a second layer of interconnected primary elements, horizontally spaced apart from the first layer; wherein the channels are formed between the first layer and the second layer.

5. The plant support structure of claim 4, wherein the channels are open on two sides.

6. The plant support structure of claim 1, wherein the channels do not include sections that extend substantially horizontally.

7. The plant support structure of claim 1, wherein the channels continuously descend vertically over their length.

8. The plant support structure of claim 1, wherein the porous material is configured to accommodate and integrate roots of the plants.

9. A system for accommodating and maintaining plants, including:
a plant support structure including a framework having a plurality of primary elements interconnected to each other in a vertically extending arrangement, the interconnected primary elements forming a plurality of geometric blocks and vertically extending channels formed at a periphery of the geometric blocks;
a porous material held within the channels, the porous material for carrying water from a top end of the plant support structure down the channels for irrigating plants in the channels; and
an irrigation system for providing water into a top part of the channels of the plant support structure.

10. The system of claim 9, wherein the system further comprises a water treatment pond located near a bottom end of the plant support structure, wherein the water treatment pond is configured to receive and purify water resulting from irrigation overflow through the channels of the plant support structure.

11. The system of claim 9, wherein the system further comprises a water storage tank for storing either the water resulting from irrigation overflow through the channels of the plant support structure or the purified water received from the water treatment pond.

12. The system of claim 11, wherein the system further comprises a cistern located at a height close or above the height of the plant support structure, wherein the cistern receives water from the water storage tank and provides the water to the irrigation system.

13. The system of claim 12, wherein the system further comprises a power source and a pump for pumping water from the water storage tank to the cistern.

14. (canceled)

15. A plant support structure for accommodating plants, the plant support structure including:
a framework including at least two layers of a plurality of geometric blocks, horizontally spaced part to form a space between the geometric blocks;
a porous material secured within the space between the geometric blocks whereby the geometric blocks and porous material form vertically extending channels for carrying water down the channels.

16. The plant support structure of claim 15, wherein the vertically extending channels form a non-linear path that substantially continuously descends along its length.

17. (canceled)

18. The plant support structure of claim 15, wherein the porous material is a wicking material.

19. The plant support structure claim 15, wherein the geometric blocks are hexagonal shaped, oriented with a vertex as an uppermost part of each block.

20. The plant support structure of claim 19, wherein the geometric blocks include one or more elongated hexagonal shaped blocks, providing increased separation between parts of the plant support structure at the location of the elongated blocks relative to non-elongated hexagonal shaped blocks.

21. The plant support structure claim 15, affixed to a structure so that the at least two layers are spaced apart from the structure.

22. The plant support structure of claim 21, further including one more platforms between an innermost layer of the at least two layers and the building, the platforms configured to accommodate thereon a person.

23. (canceled)
